(19) United States
(12) Patent Application Publication
(10) Pub. No.: US 2007/0037103 A1
(43) Pub. Date: Feb. 15, 2007

(54) BISPHENOL COMPOUND AND PHOTOTHERMOGRAPHIC MATERIAL

(75) Inventors: Kiyoshi FUKUSAKA, Tokyo (JP); Osamu ISHIGE, Tokyo (JP); Takeshi KURATA, Tokyo (JP)

Correspondence Address: LUCAS & MERCANTI, LLP, 475 PARK AVENUE SOUTH, 15TH FLOOR, NEW YORK, NY, 10016, US

(73) Assignee: KONICA MINOLTA MEDICAL & GRAPHIC, INC., Tokyo (JP)

(21) Appl. No.: 11/460,326

(22) Filed: Jul. 27, 2006

(30) Foreign Application Priority Data
Aug. 9, 2005 (JP) JP2005-230696

(51) Int. Cl. G03C 1/00

(52) U.S. Cl. 430/619

(57) ABSTRACT

A photothermographic material is disclosed, comprising on at least one side of a support a light-sensitive layer containing a light-sensitive silver halide and a light-insensitive organic silver salt, wherein the photothermographic material further comprises at least a reducing agent represented by the following formula (1):

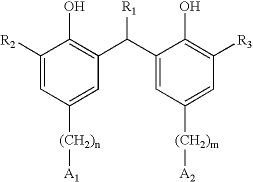

This application claims priority from Japanese Patent Application No. JP2005-230696 filed on Aug. 9, 2005, which is incorporated hereinto by reference.

### FIELD OF THE INVENTION

The present invention relates to bisphenol compounds, thermally developable photothermographic materials by use thereof and an image forming method.

### BACKGROUND OF THE INVENTION

In the field of medical treatment and graphic arts, there have been concerns in processing of imaging materials with respect to effluent produced from wet-processing, and recently, reduction of the processing effluent is strongly demanded in terms of environmental protection and space saving. There has been desired a photothermographic dry imaging material for photographic use, capable of forming distinct black images exhibiting high sharpness, enabling efficient exposure by means of a laser imager or a laser image setter.

Known as such a technique are silver salt photothermographic dry imaging materials comprising an organic silver salt, light-sensitive silver halide and a reducing agent on a support, as described in U.S. Pat. Nos. 3,152,904 and 3,487,075 by D. Morgan and B. Shely, and D. H. Klosterboer, “Dry Silver Photographic Material” (Handbook of Imaging Materials, Marcel Dekker Inc. page 48, 1991). Such a silver salt photothermographic dry imaging material (hereinafter also denoted simply as photothermographic material), which does not employ any solution type processing chemical, can provide users a simple and environment-friendly system.

In one aspect, this photothermographic material contains light-sensitive silver halide as a photosensor and a light-insensitive aliphatic carboxylic acid silver salt (hereinafter, also denoted as an organic silver salt) as a silver ion source, and is thermally developed usually at 80° C. or higher by an included reducing agent for silver ions (hereinafter also denoted simply as a reducing agent) to form an image, without performing fixation.

However, photothermographic materials, in which an organic silver salt and light-sensitive silver halide are contained together with a reducing agent, readily causes fogging after raw stock. After being exposed, the photothermographic material is thermally developed and remains unfixed. After being subjected to thermal development, all or a part of the silver halide, organic silver salt and reducing agent remain, so that metallic silver is thermally or photolytically formed after storage over a long period, resulting in problems such as change in image quality, for instance, silver image color.

Recently, speedup in thermal development has advanced and it is desired to obtain images of high density for a shorter time. Useful as a means for overcoming such problems are reducing agents, as described in JP-A Nos. 2001-188314, 2004-4650 and 2004-4767 (hereinafter, the term, JP-A refers to Japanese Patent Application Publication). However, the use of such reducing agents produced problems that fogging was easily caused when photothermographic material was aged over a long duration before being developed or when silver images obtained in thermal development was stocked over a long duration after being developed. Further, formed silver images became yellowish over time, resulting in lowered diagnostic capability in medical use. Accordingly, further improvements are demanded.

### SUMMARY OF THE INVENTION

In view of the foregoing, it is an object of the present invention to provide a thermally developable photothermographic material exhibiting superior raw stock stability as well as reduced fogging and improved storage stability of silver images, and achieving a high maximum density and superior silver image color even in thermal development for a short time and an image forming method by use thereof, and a novel bisphenol compounds.

Further objects of the invention will become apparent from the description hereinafter.

The above-mentioned objects are realized by the following constitution.

One aspect of the invention is directed to a thermally developable photothermographic material comprising on at least one side of a support a light-sensitive layer containing light-sensitive silver halide, wherein the photothermographic material further comprises at least a compound represented by the following formula (1): 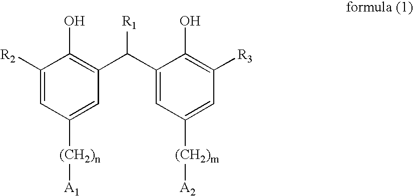
wherein R₁ is a hydrogen atom or a substituent; R₂ and R₃ are each independently a branched alkyl group having 3 to 6 carbon atoms; A₁ and A₂ are each independently a hydroxy group or a group capable of forming a hydroxy group upon deprotection; n and m are each an integer of 3 to 5.

Another aspect of the invention is directed to an image forming method comprising exposing the above-described photothermographic material to exposure by using a laser light source and subjecting the exposed photothermographic material to thermal development at a temperature of 80 to 200° C.

Further, another aspect of the invention is directed to a bisphenol compound represented by the following formula (2): 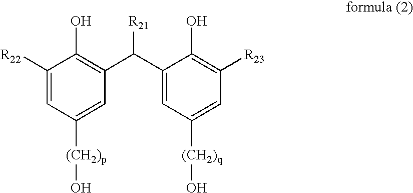
wherein R₂₁ is a hydrogen atom or a substituent; R₂₂ and R₂₃ are each independently a tertiary alkyl group having 5 or 6 carbon atoms; p and q are each an integer of 3 to 5.

### DETAILED DESCRIPTION OF THE INVENTION

While the invention will hereinafter be described in connection with preferred embodiments thereof, it is to be understood that it is not intended to limit the invention to those embodiments. On the contrary, it is intended to cover all alternatives, modifications, and equivalents as may be included within the spirit and scope of the invention as defined by the appending claims.

In the foregoing formula (1), R₁ is a hydrogen atom or a substituent. Examples of a substituent include an alkyl group, a cycloalkyl group, an alkenyl group, an alkynyl group, an aryl group, a heterocyclic group, a halogen atom and cyano group. Of these, a hydrogen atom, an alkyl group, a cycloalkyl group or an alkenyl group is preferred, and a hydrogen atom or an alkyl group is more preferred. These substituents may further be substituted. Examples of such a substituent include an alkyl group, a cycloalkyl group, a halogenated alkyl group, an alkenyl group, alkynyl group, an aryl group, a heterocyclic group, a halogen atom, cyano group, hydroxy group, carboxy group, an alkoxy group, an aryloxy group, silyloxy group, heterocyclic-oxy group, an acyloxy group, a carbamoyloxy group, an alkoxycarbonyloxy group, an aryloxycarbonyloxy group, an amino group, an anilino group, an acylamino group, an aminocarbonylamino group, an alkoxycarbonylamino group, an aryloxycarbonylamino group, a sulfamoylamino group, an alkyl- or aryl-sulfonylamino group, mercapto group, an alkylthio group, an arylthio group, a heterocyclic-thio group, a sulfamoyl group, a sulfo group, an alkyl- or aryl-sulfinyl group, an alkyl- or aryl-sulfonyl group, an acyl group, an aryloxycarbonyl group, an alkoxycarbonyl group, a carbamoyl group, an aryl- or heterocyclic-azo group, an imido group, a silyl group, a hydrazine group, a ureido group, a boronic acid group, a phosphate group, sulfato group and other substituent groups.

R₂ and R₃ are each independently a branched alkyl group having 3 to 6 carbon atoms. Examples of such a branched alkyl group include tert-butyl, tert-amyl, isopropyl, isobutyl, 1,1-imethylbutyl, 1-methylcyclopentyl, 1-methylcyclobutyl, 1-methylcyclopropyl, 1-methylbutyl, 1,3-dimethylbutyl, 1-methylpropyl, 1,1,2-trimethylpropyl, and 1-ethyl-1-methylpropyl. Of these, tert-butyl, 1,1-dimethylbutyl or tert-amyl is preferred, and tert-amyl is more preferred. These branched alkyl groups may be substituted and examples of a substituent include hydroxy, cyano, mercapto, a halogen atom, an amino group, imido group, a silyl group, and a hydrazino group.

A₁ and A₂ are each a hydroxy group or a group capable of forming a hydroxy group upon deprotection, and preferably a hydroxy group. The group capable of forming a hydroxy group upon deprotection is a group which is cleaved (or deprotected) under the action of an acid and/or heat to form a hydroxy group. Specific examples thereof include an ether group (e.g., methoxy, tert-butoxy, allyoxy, benzoyloxy, triphenylmethoxy, trimethylsilyloxy), a hemiacetal group (e.g., tetrahydropyranyloxy), an ester group (e.g., acetyloxy, benzoyloxy, p-nitrobenzoyloxy, formyloxy, trifluoroacetyloxy, pivaloyloxy), a carbonato group (e.g., ethoxycarbonyloxy, phenoxycarbonyloxy, tert-butyloxycarbonyloxy), a sulfonate group (e.g., p-toluenesulfonyloxy, benzenesulfonyloxy), a carbamoyloxy group (e.g., phenylcarbamoyloxy), a thiocarbonyloxy group (e.g., benzylthiocarbonyloxy), a nitric acid ester group, and a sulphenato group (e.g., 2,4-dinitrobenzenesulphenyloxy).

Further, n and m are each an integer of 3 to 5, preferably 3 or 4, and more preferably 3.

In the foregoing formula (2), R₂₁ is a hydrogen atom or an alkyl group. Examples of an alkyl group include methyl ethyl isopropyl, propyl, butyl and, isobutyl; R₂₂ and R₂₃ are each a tertiary alkyl group having 5 or 6 carbon atoms, and examples thereof include tert-amyl, 1,1-dimethylbutyl, 1,1,2-trimethylpropyl, 1-ethyl-1-methylpropyl, 1-methylcyclopentyl, 1-methylcyclobutyl and 1-methylcyclopropyl; p and q are each an integer of 3 to 5.

Specific examples of compounds represented by formulas (1) and (2) are shown below but the present invention are by no means limited to these.

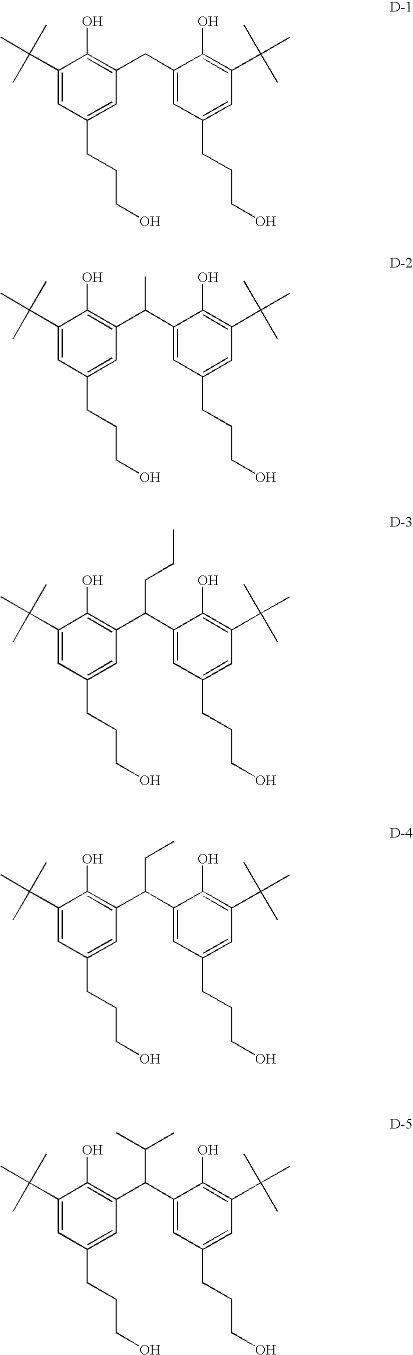

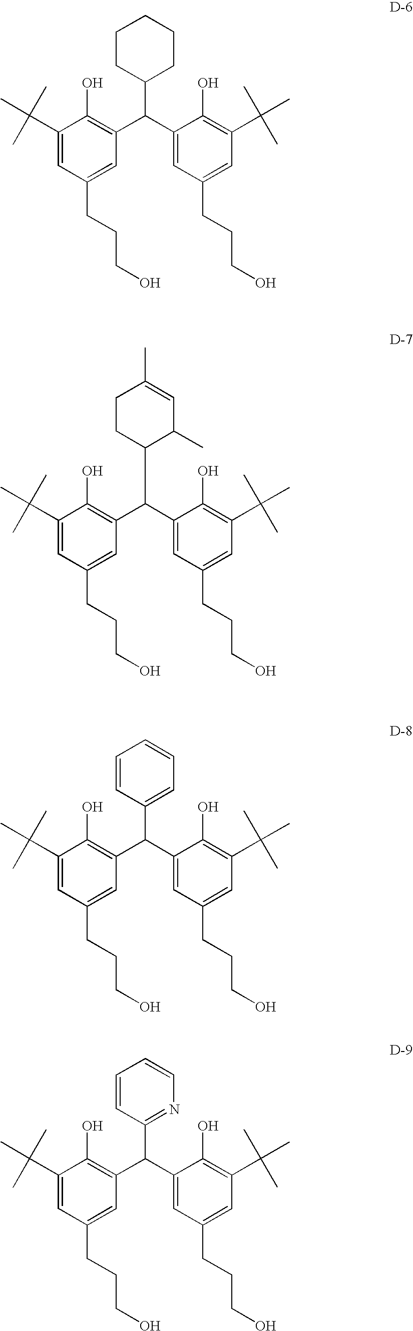

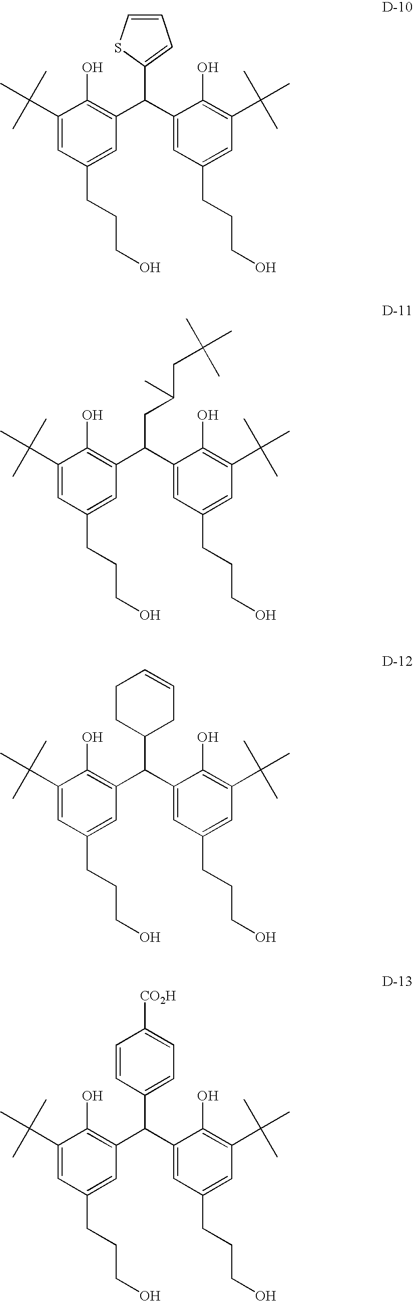

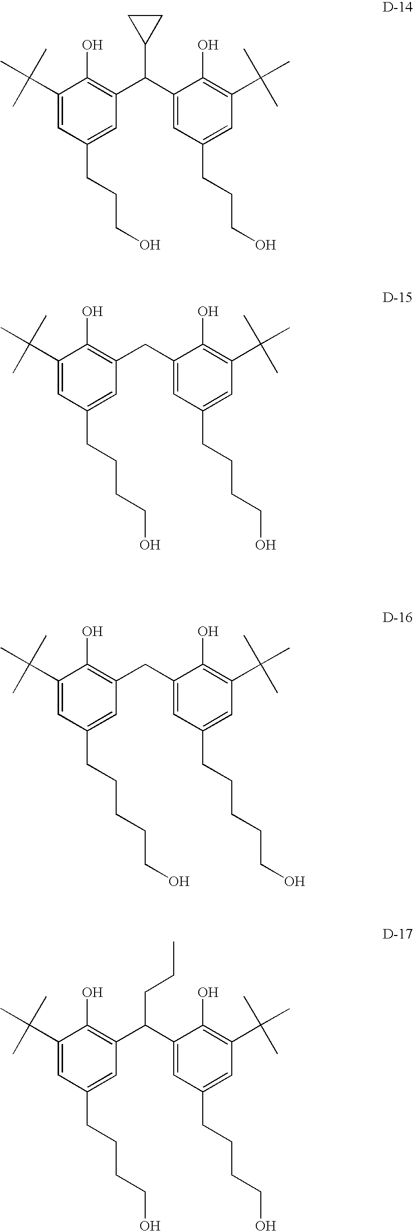

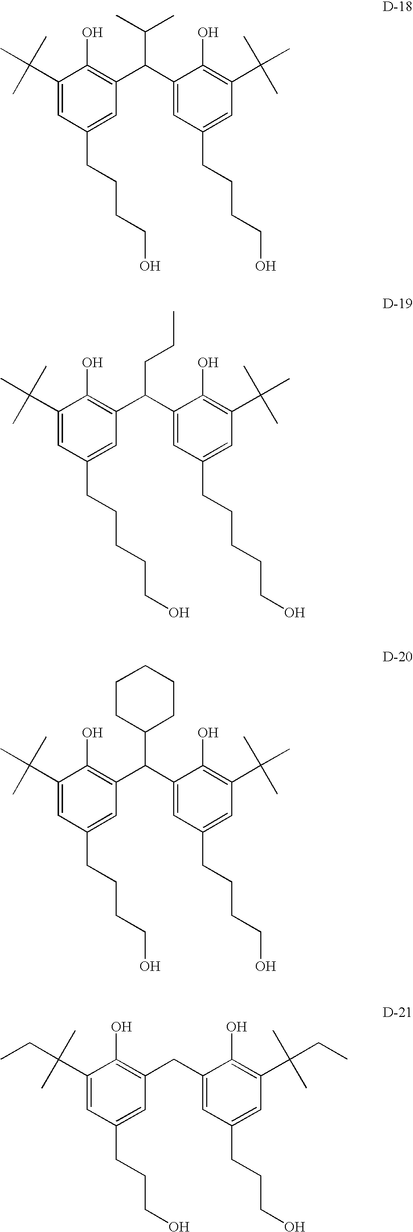

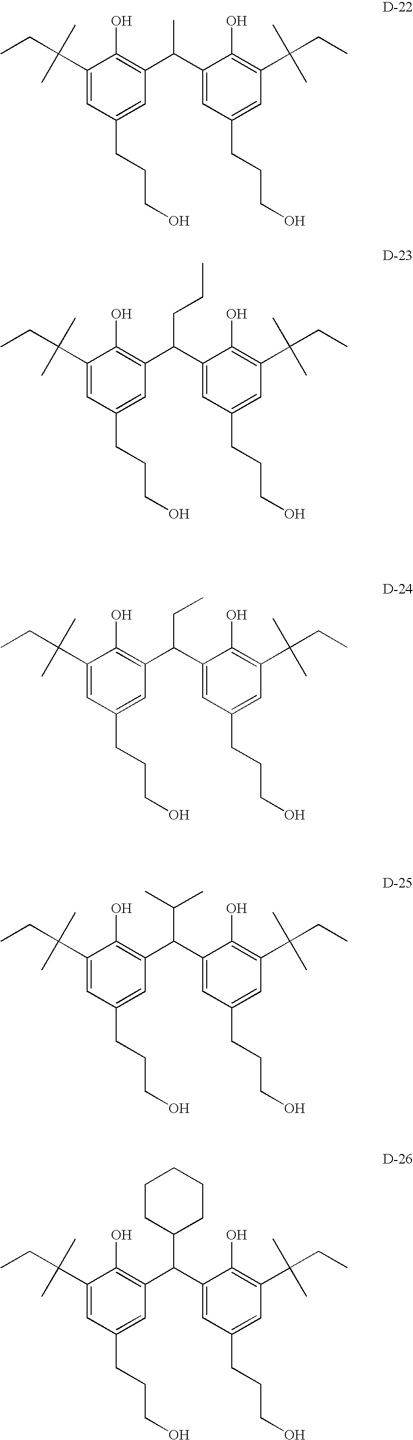

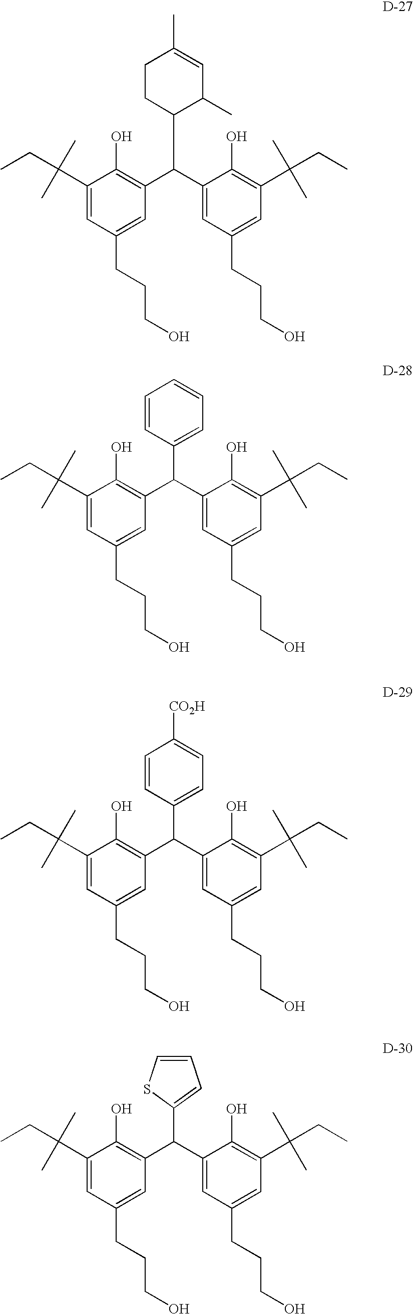

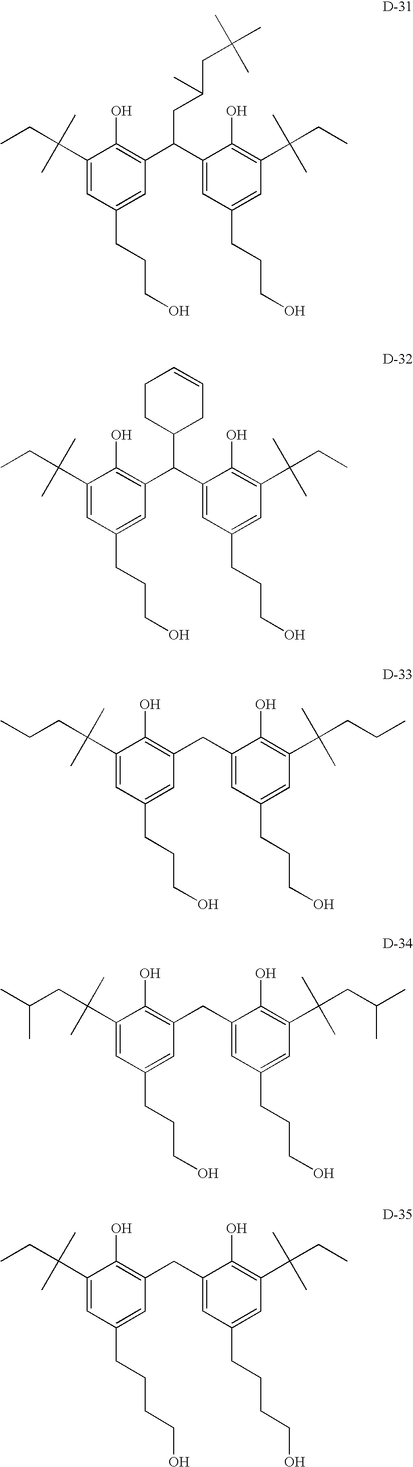

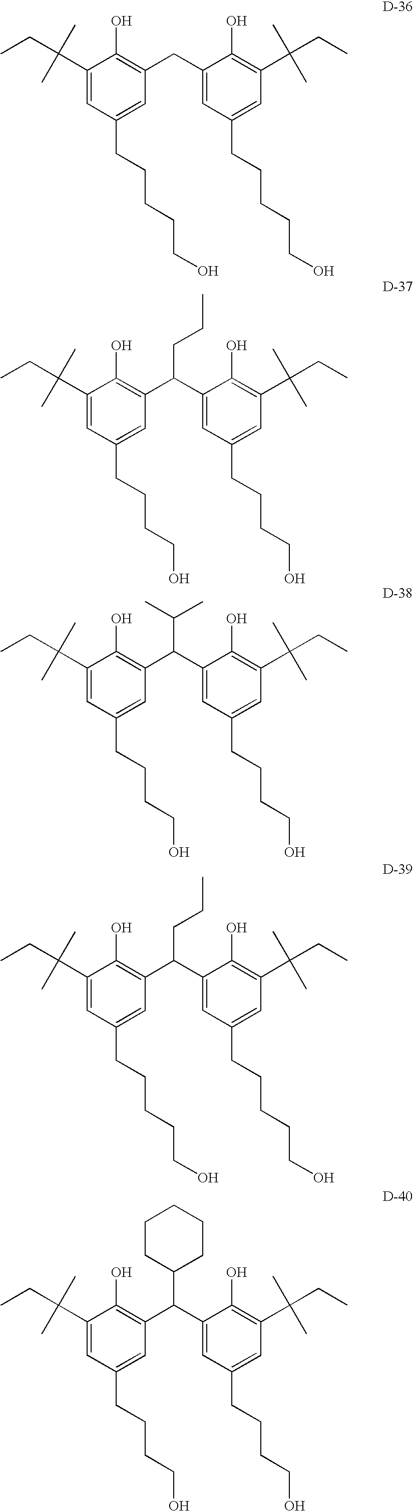

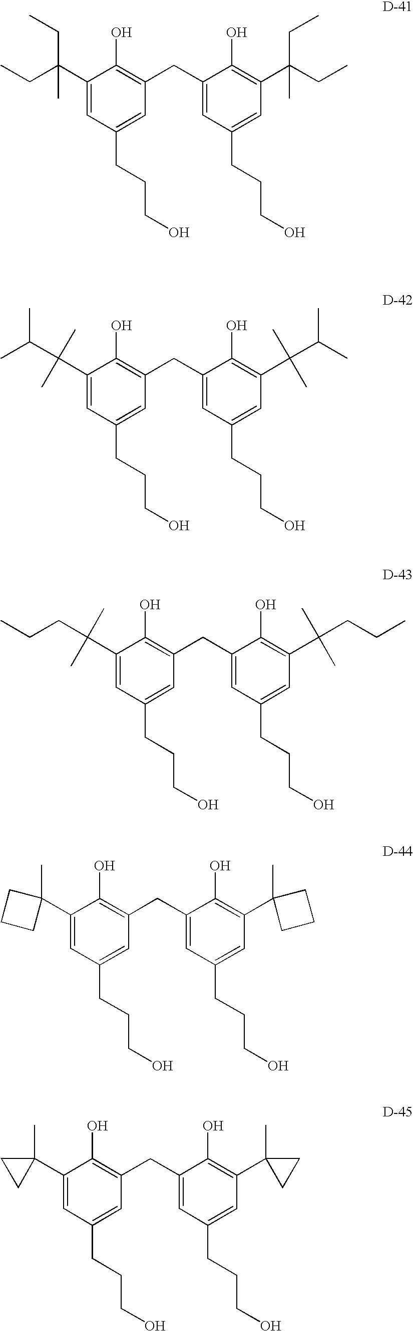

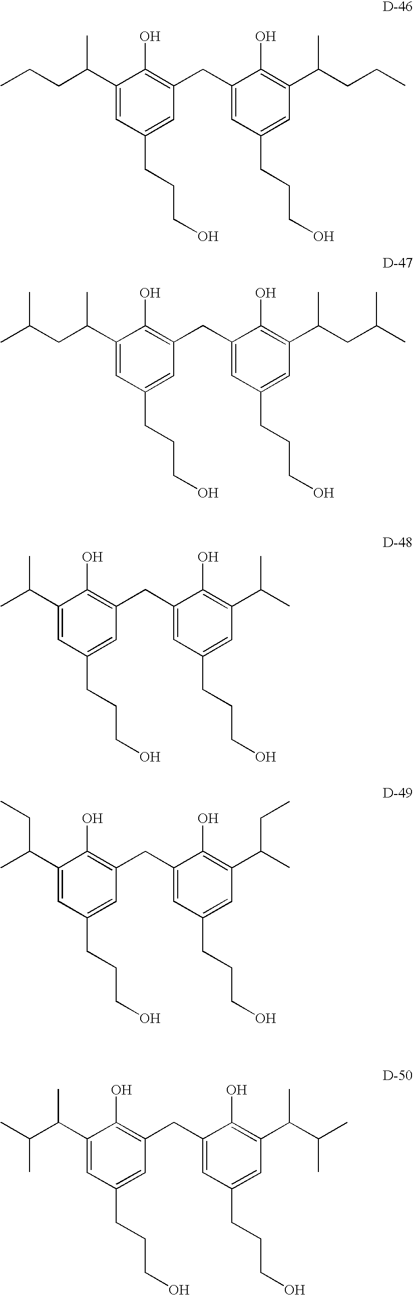

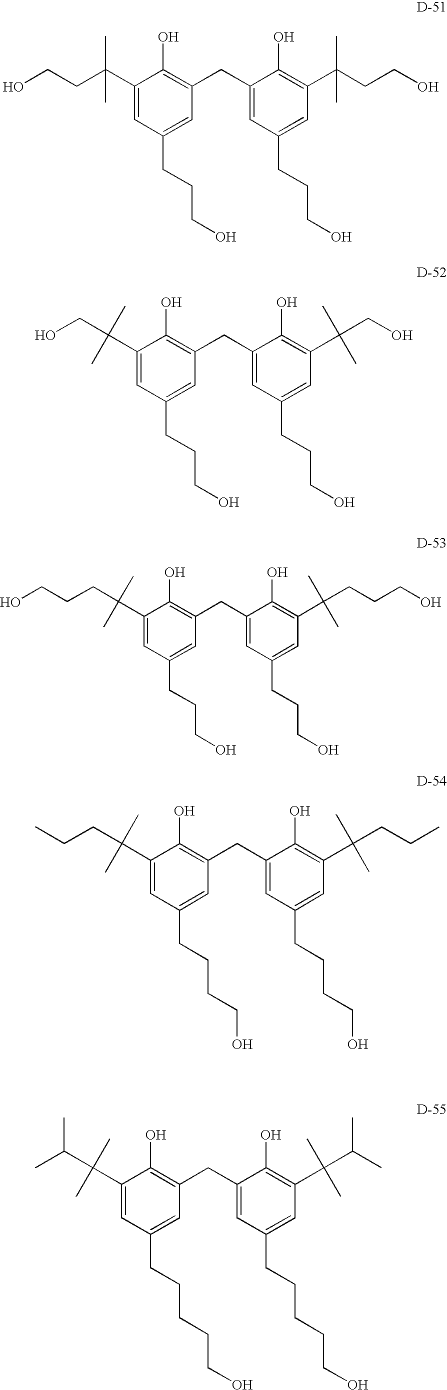

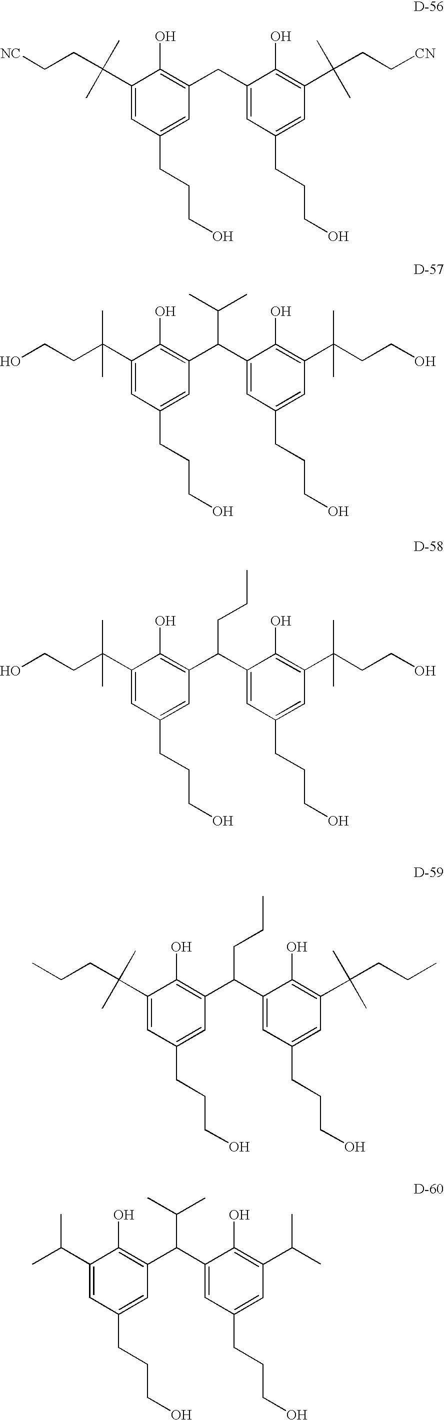

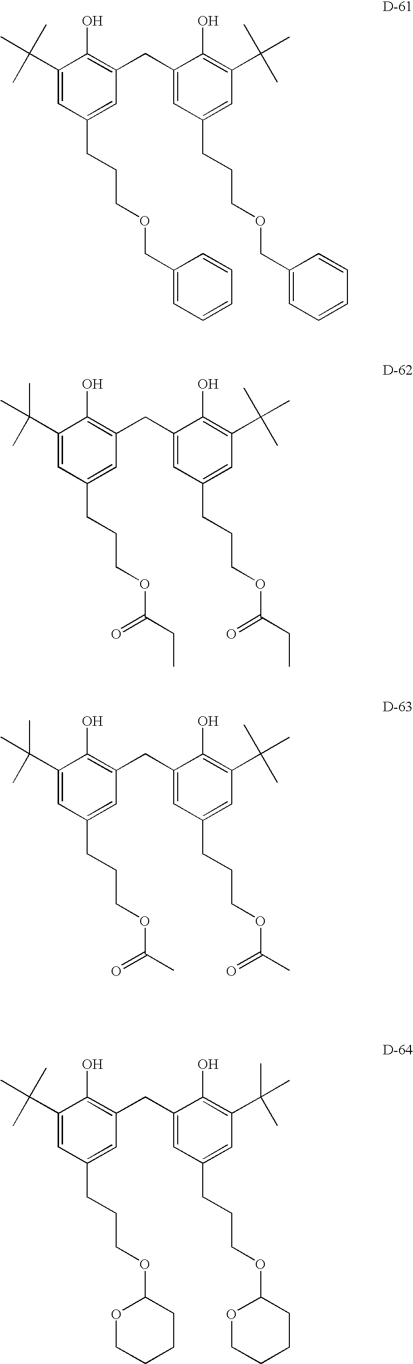

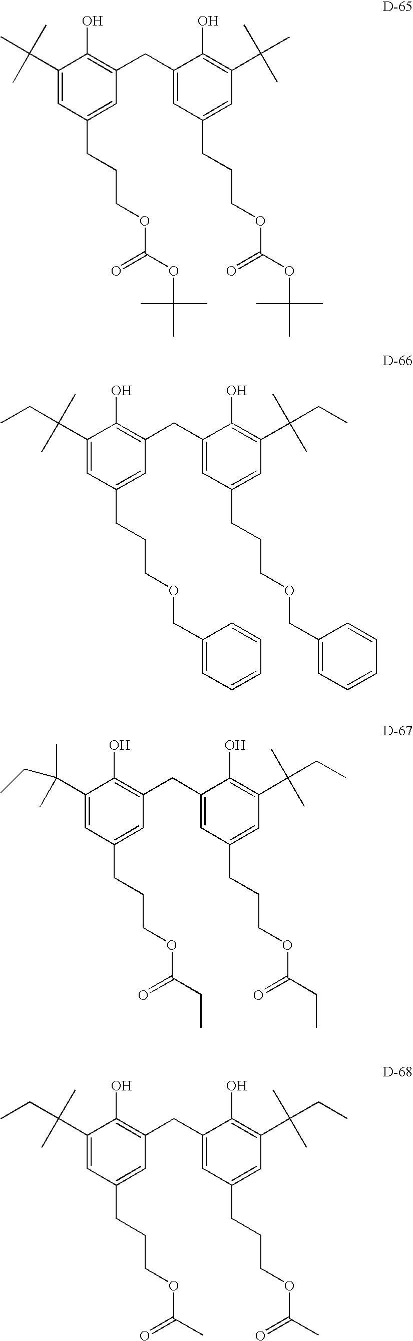

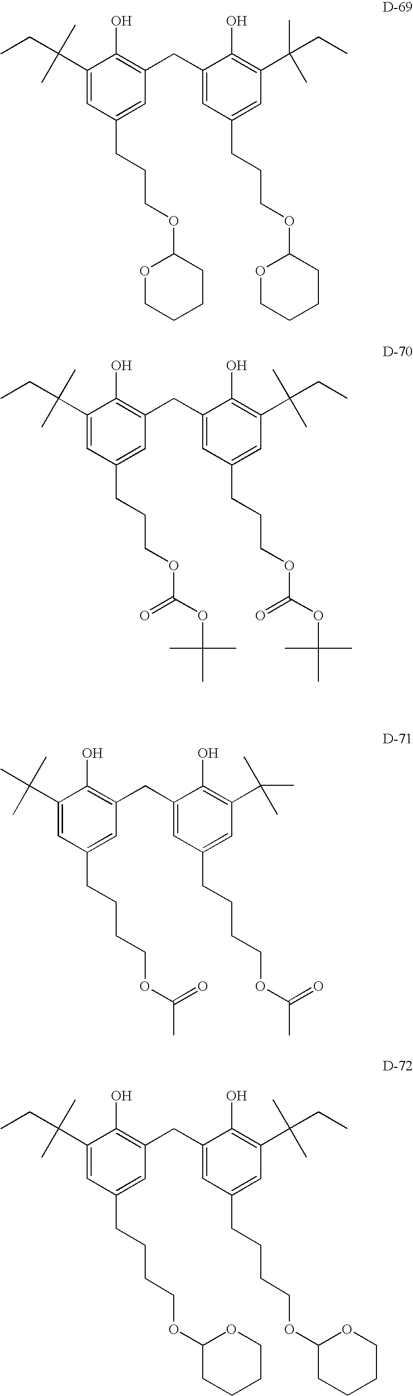

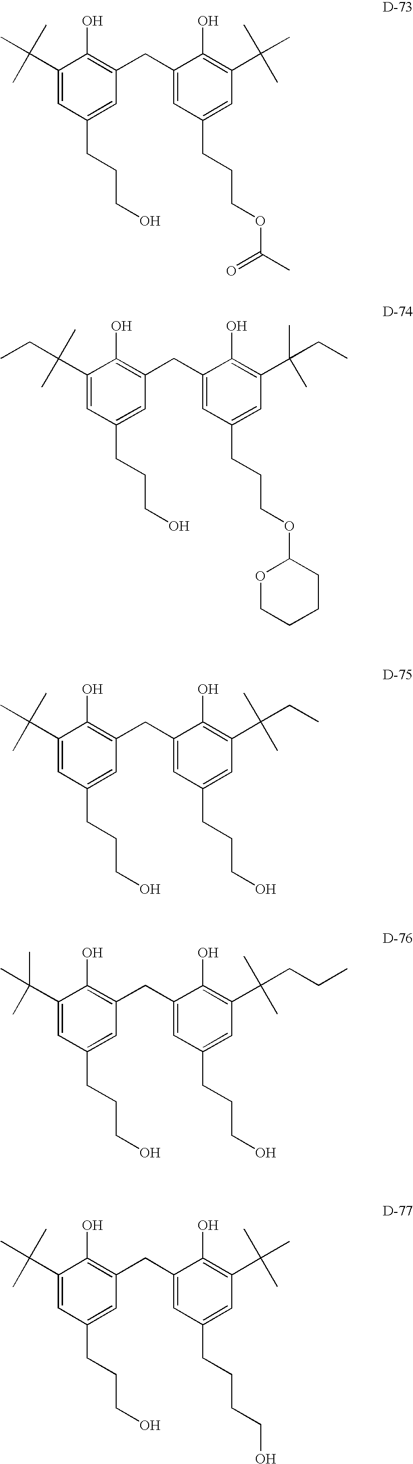

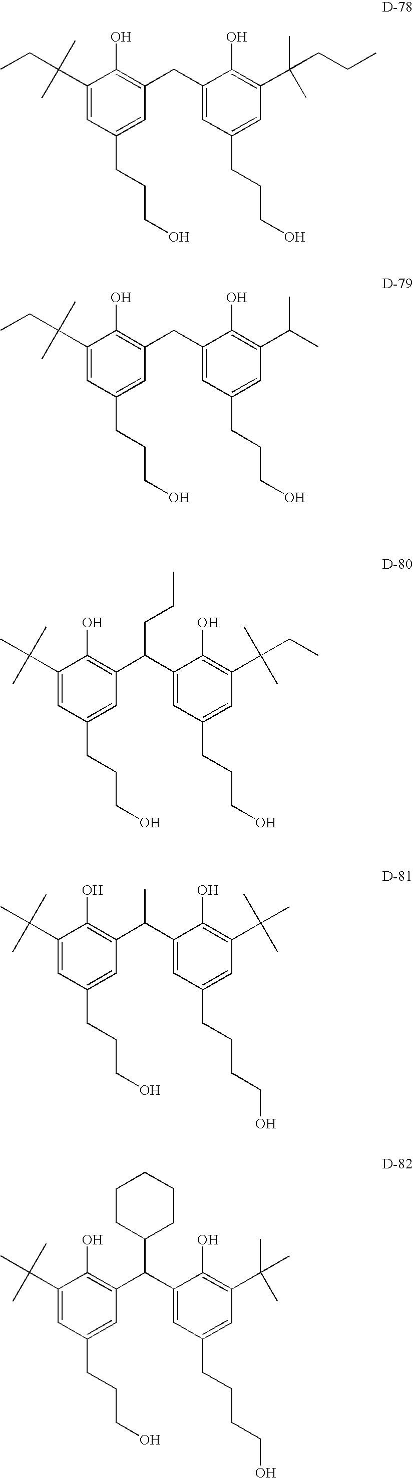

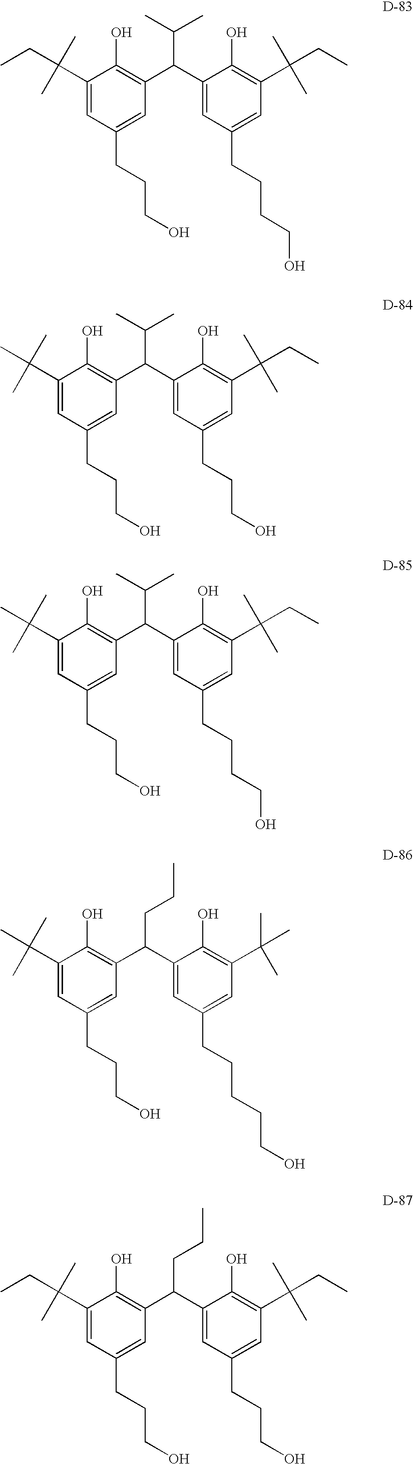

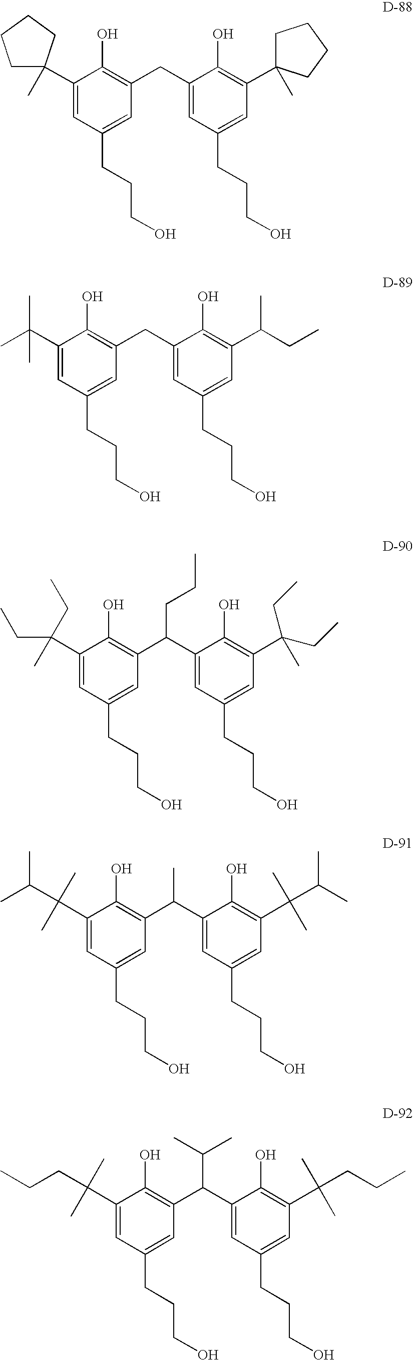

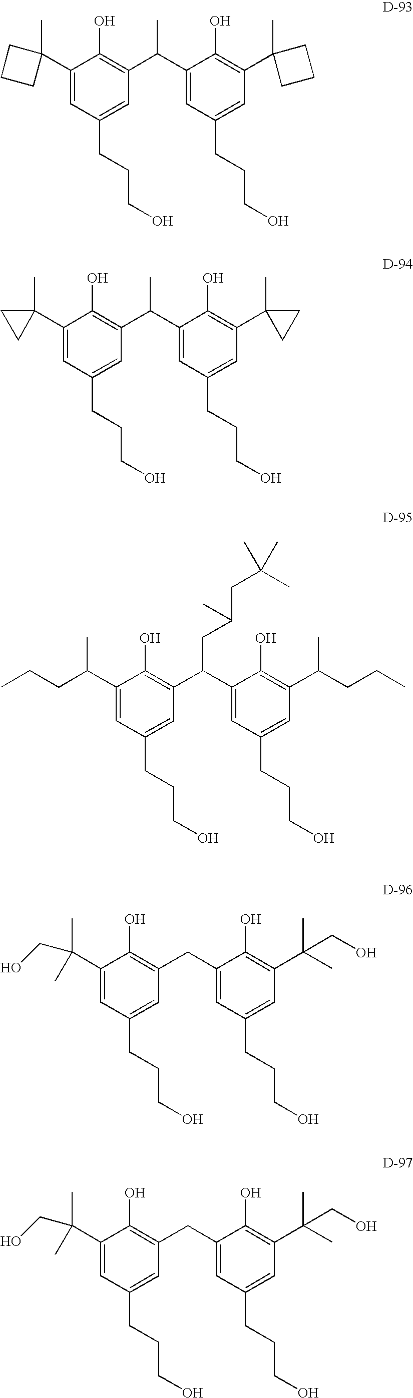

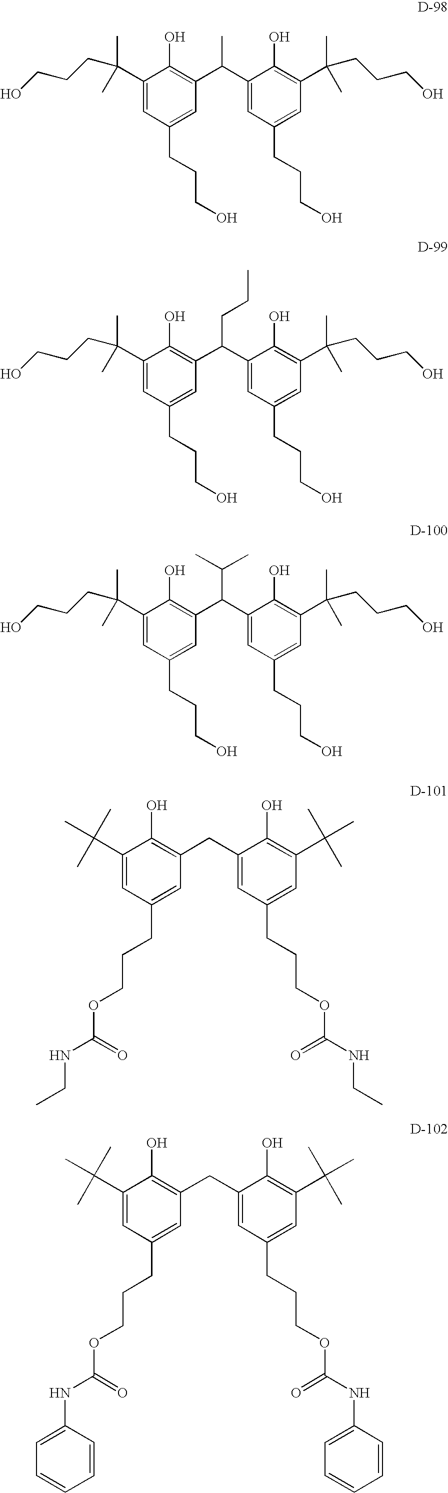

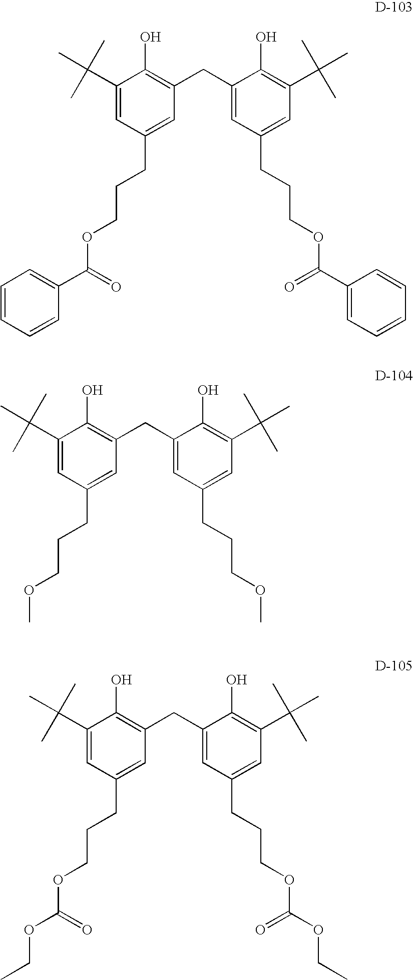

The compound of formula (1) as a reducing agent may be used alone or in combination thereof, or may be used in combination with other reducing agents. Reducing agents usable in combination with the compound of formula (1) are those described in JP-A No. 11-65021, paragraph No. 0043-0045; European Patent Application Publication No. 830,764A1, page 7, line 34 to page 18, line 12; JP-A No. 2003-302723, paragraph No. 0124-0133; JP-A No. 2003-315954, paragraph No. 0124-0127; and JP-A No. 2004-4650, paragraph No. 0042-0057. In the photothermographic material of the invention, specifically bisphenol reducing agents e.g., 1,1-bis(2-hydroxy-3,5-dimethylphenyl)-3,5,5-trimethylhexane and bis(2-hydroxy-3,5-dimethylphenyl)-cyclohexylmethane, are preferably used in combination with the compounds of formula (1).

The compound of formula (1) may be incorporated into a light-sensitive layer containing an organic silver salt or an adjacent light-insensitive layer.

The foregoing reducing agents may be incorporated into the photothermographic material in any appropriate form, such as an emulsified dispersion or a solid particle dispersion.

Further, polyphenol compounds described in U.S. Pat. Nos. 3,589,903 and 4,021,249, British Patent No. 1,486,148, JP-A Nos. 51-51933, 50-36110, 50-116023 and 52-84727, and JP-B No. 51-35727 (hereinafter, the term JP-B refers to Japanese Patent Publication); bisnaphthols such as 2,2′-dihydroxy-1,1′-binaphthyl, described in U.S. Pat. No. 3,672,904; and sulfonamidophenol or sulfonamidonaphthol, such as 4-benzenesulfonamidophenol, 2-benzenesulfonamidophenol, 2,6-dichloro-4-benzenesulfonamidophenol and 4-benzenesulfonamidonapthol are also usable as a reducing agent.

The content of a reducing agent, depending on the kind of an organic silver salt or the reducing agent, or other additives, is generally from 0.05 to 10 mol per mol of organic silver salt, and preferably from 0.1 to 3 mol. In the invention, it is often preferred that the reducing agent is added to a light-sensitive emulsion containing light-sensitive silver halide and organic silver salt grains, immediately before coating and then coated, whereby variation in photographic performance while standing is minimized.

Subsequently, thermally developable photothermographic materials of the invention will be described.

An organic silver salt usable in the invention is a reducible silver source and an organic acid including a reducible silver ions. Organic acids usable in the invention include an aliphatic carboxylic acid, a carbocyclic carboxylic acid, heterocyclic carboxylic acid, and heterocyclic compounds. Of these, a long chain aliphatic carboxylic acid (having 10 to 30 carbon atoms, and preferably 15 to 25 carbon atoms) and a nitrogen-containing heterocyclic carboxylic acid are preferably used. An organic silver salt complex having a ligand exhibiting an overall stability constant for a silver ion of 4.0-10.0 is also useful. Examples of organic silver salts include those described in Research Disclosure (hereinafter, also denoted simply as RD) Nos. 17029 and 29963. Specifically, fatty acid silver salts are preferred and silver behenate, silver arachidate or silver stearate is more preferred.

Organic silver salt compounds can be obtained by mixing a water-soluble silver compound and a compound capable of forming a salt with silver, in which a normal mixing method, reversed mixing method or simultaneous mixing method is preferably employed. Controlled double-jet precipitation is also applicable, as described in JP-A No. 9-127643.

Organic silver salt grains usable in the invention exhibit an average grain size of 1 μm or less and are preferably monodisperse. The grain size of an organic silver salt grain refers to the diameter of a sphere having a volume equivalent to that of the grain when organic silver salt grains are in a spherical, bar-like or tabular form. The average grain size is preferably from 0.01 to 0.8 μm, and more preferably from 0.05 to 0.5 μm. The expression, monodisperse has the same meaning as in silver halide grains described later and the monodispersibility is preferably from 15 to 30%. More preferably, an organic silver salt used in the invention is comprised of monodisperse grains having an average grain size of 1 μm or less, thereby achieving enhanced image density. At least 60% of total organic silver salt grains is preferably accounted for by tabular grains. In the invention, the tabular grains refer to those exhibiting an aspect ratio (denoted as AR) of at least 3 and defined below:
AR=average grain size (μm)/grain thickness (μm).
Organic silver salt grains are optionally subjected to preliminary dispersion together with a binder or a surfactant, pulverized and then dispersed preferably using a media dispersing machine or a high pressure homogenizer. Dispersing machines usable in the above-mentioned preliminary dispersion include, for example, a general use stirring machines of an anchor type, a propeller type or the like, a high-speed rotary centrifugal radiation-type stirrer (dissolver), and a high-speed rotary shearing type stirrer (homogenizer). Examples of the media dispersing machine include a rolling mill such as a ball mill, a planetary ball mill or a vibration mill, a medium-stirring mill such as a beads mill, an atriter, and a basket mill. Various types of high pressure homogenizers are also sable, for example, a type of colliding to a wall or plug, a type of dividing a stream of liquid and allowing the divided liquid streams to collide with each other at a high-speed and a type of passing through a thin orifice.

In devices used for dispersing organic silver salt rains usable in the invention, materials in contact with the organic silver salt grains are preferably ceramics such as zirconia, alumina, silicon nitride or boron nitride or diamond, and more preferably zirconia.

Organic silver salt grains preferably contain Zr in an amount of 0.01 to 0.5 mg per gram of silver, and more preferably 0.01 to 0.3 mg. Optimization of binder concentration, preliminary dispersion, operating conditions of a dispersing machine and the number of times for dispersion is preferable to obtain targeted organic silver salt grains.

In order to minimize cloudiness after image formation and to attain excellent image quality, the lower the average grain size, the more preferred, and the average grain size of light-sensitive silver halide grains is preferably not less than 0.1 μm, more preferably 0.01 to 0.1 μm, and still more preferably 0.02 to 0.08 μm. The grain size refers to the diameter of a circle having an area equivalent to the area of the microscopically observed, individual grain, so-called circular equivalent diameter. Furthermore, silver halide grains are preferably monodisperse grains. The monodisperse grains as described herein refer to grains having a monodispersibility of grain size defined by the formula described below of not more than 40%; more preferably not more than 30%, still more preferably not more than 20%, and most preferably not more than 1%.
Monodispersibility of grain size=(standard deviation of grain diameter/average grain diameter)×100 (%)
The grain form of silver halide is not specifically limited. In cases when using a spectral sensitizing dye exhibiting crystal habit (face) selectivity in the adsorption reaction of the sensitizing dye onto the silver halide grain surface, it is preferred to use silver halide grains having a relatively high proportion of the crystal habit meeting the selectivity. In cases when using a sensitizing dye selectively adsorbing onto the crystal face of a Miller index of [100], for example, a high ratio accounted for by a Miller index [100] face is preferred. This ratio is preferably at least 50%, is more preferably at least 70%, and is still more preferably at least 80%. The ratio accounted for by the Miller index [100] face can be obtained based on T. Tani, J. Imaging Sci., 29, 165 (1985) in which adsorption dependency of a [111] face or a [100] face is utilized.

Tabular light-sensitive silver halide grains are also preferable in the invention. The tabular grains refer to those exhibiting an aspect ratio (denoted as r/h) of 3 or more, in which “r” is grain diameter (μm), represented as a square root of the projected area of the tabular grain and h is vertical thickness (μm). The aspect ratio is preferably from 3 to 50. The tabular grain diameter is preferably not more than 0.1 μm, and more preferably from 0.01 to 0.08 μm. Tabular silver halide grains are described in U.S. Pat. Nos. 5,264,337, 5,314,798 and 5,320,958 and objective tabular grains can be readily obtained.

The halide composition of silver halide is not specifically limited and may be any one of silver chloride, silver chlorobromide, silver iodochlorobromide, silver bromide, silver iodobromide and silver iodide. The silver halide grains used in the invention can be prepared according to the methods described in P. Glafkides, Chimie Physique Photographique (published by Paul Montel Corp., 1967; G. F. Duffin, Photographic Emulsion Chemistry (published by Focal Press, 1966); V. L. Zelikman et al., Making and Coating of Photographic Emulsion (published by Focal Press, 1964). Light-sensitive silver halide preferably includes metal ions selected from groups 6 to 11 inclusive of the periodic table of elements. The foregoing metal is preferably W, Fe, Co, Ni, Cu, Ru, Rh, Pd, Re, Os, Ir, Pt or Au.

The metal ions can be introduced into silver halide in the form of a metal complex or a metal complex ion. The metal complex or metal complex ion is preferably a six-coordinate metal complex represented by the following formula:
[ML₆]^{m} formula
wherein M represents a transition metal selected from elements in Groups 6 to 11 of the Periodic Table; L represents a coordinating ligand; and m represents 0, 1-, 2-, 3- or 4-. M is selected preferably from W, Fe, Co, Ni, Cu, Ru, Rh, Pd, Re, Os, Ir and Pt. Exemplary examples of the ligand represented by L include halides (fluoride, chloride, bromide, and iodide), cyanide, cyanato, thiocyanato, selenocyanato, tellurocyanato, azido and aquo, nitrosyl, thionitrosyl, etc., of which aquo, nitrosyl and thionitrosyl are preferred. When an aquo ligand is present, one or two ligands are preferably coordinated. L may be the same or may be different.

M is preferably rhodium (Rh), ruthenium (Ru), rhenium (Re), iridium (Ir) or osmium (Os). Specific examples of a transition metal complex ion include

[RhCl₆]³⁻, [RuCl₆]³⁻, [ReCl₆]³⁻, [RuBr₆]³⁻, [OsCl₆]³⁻, [CrCl₆]⁴⁻, [IrCl₆]⁴⁻, [IrCl₆]³⁻. [Ru(NO)Cl₅]²⁻, [RuBr₄(H₂O)]²⁻, [Ru(NO)(H₂O)Cl₄]⁻, [RhCl₅(H₂O)]²⁻, [Re(NO)Cl₅]²⁻, [Re(NO)(CN) ₅]²⁻, [Re(NO)Cl(CN)₄]², [Rh(NO)₂Cl₄]⁻, [Rh(NO)(H₂O)Cl₄], [Ru(NO)(CN)₅]²⁻, [Fe(CN)₆]³⁻, [Rh(NS)Cl₅]²⁻, [Os(NO)Cl₅]²⁻, [Cr(NO)Cl₅]²⁻, [Re(NO)Cl₅]⁻, [Os(NS)Cl₄(TeCN)]²⁻, [Ru(NS)Cl₅]²⁻, [Re(NS)Cl₄(SeCN)]²⁻, [Os(NS)Cl(SCN)₄]²⁻ and [Ir(NO)Cl₅]²⁻.

The foregoing dopants may be used alone or in combination thereof. The dopant content is preferably 1×10⁻⁹ to 1×10⁻² mol and more preferably 1×10⁻⁸ to 1×10⁻⁴ mol per mol of silver.

Compounds, which provide these metal ions or complex ions, are preferably incorporated into silver halide grains through addition during the silver halide grain formation. These may be added during any preparation stage of the silver halide grains, that is, before or after nuclei formation, growth, physical ripening, and chemical ripening. However, they are preferably added at the stage of nuclei formation, growth, and physical ripening; furthermore, they are preferably added at the stage of nuclei formation and growth; and are most preferably added at the stage of nuclei formation.

These compounds may be added several times by dividing the total added amount. Uniform content in the interior of a silver halide grain can be carried out. As disclosed in JP-A No. 63-29603, 2-306236, 3-167545, 4-76534, 6-110146 and 5-273683, the metal can be non-uniformly occluded in the interior of the grain. These metal compounds can be dissolved in water or a suitable organic solvent (e.g., alcohols, ethers, glycols, ketones, esters, amides, etc.) and then added. Furthermore, there are methods in which, for example, an aqueous solution of a powdered metal compound or an aqueous solution in which a metal compound is dissolved along with NaCl and KCl is added to a water-soluble silver salt solution during grain formation or to a water-soluble halide solution; when a silver salt solution and a halide solution are simultaneously added, a metal compound is added as a third solution to form silver halide grains, while simultaneously mixing the three solutions; during grain formation, an aqueous solution comprising the necessary amount of a metal compound is placed in a reaction vessel; or during silver halide preparation, dissolution is carried out by the addition of other silver halide grains previously doped with metal ions or complex ions. Specifically, the preferred method is one in which an aqueous solution of a powdered metal compound or an aqueous solution in which a metal compound is dissolved along with NaCl and KCl is added to a water-soluble halide solution. When the addition is carried out onto grain surfaces, an aqueous solution comprising the necessary amount of a metal compound can be placed in a reaction vessel immediately after grain formation, or during physical ripening, at the completion thereof or during chemical ripening.

Silver halide grain emulsions used in the invention may be desalted after the grain formation, using the methods known in the art, such as the noodle washing method or flocculation process.

Silver halide grains are preferably chemically sensitized. Commonly known sulfur sensitization, selenium sensitization or tellurium sensitization is applicable as preferred chemical sensitization. There is also applicable noble metal sensitization using gold compounds or platinum, palladium or iridium compounds, or reduction sensitization.

Compounds known in the art are usable in the above-mentioned sulfur sensitization, selenium sensitization or tellurium sensitization, as described in, for example, JP-A No. 7-128768. Examples of a tellurium sensitizer include diacyltellurides, bis(oxycarbonyl)tellurides, bis(carbamoyl)tellurides, diacyltellurides, bis(oxycarbonyl)ditellurides, bis(carbamoyl)ditellurides, P=Te bond-containing compounds, tellurocarboxylates, Te-organyltellurocarboxylic acid esters, di(poly)tellurides, tellurides, tellurols, telluroacetals, tellurosulfonatos, P—Te bond-containing compounds, Te-containing compounds, tellurocarbonyl compounds, inorganic tellurium compounds and colloidal tellurium.

Examples of preferred compounds usable in noble sensitization include chloroauric acid, potassium chloaurate, potassium aurithicyanate, gold sulfide, gold selenide, or the compounds described in U.S. Pat. No. 2,448,060 and British Patent No. 618,061.

Compounds usable in reduction sensitization include, for example, tin(II) chloride, aminoiminomethanesulfinic acid, hydrazine derivatives, borane compounds, silane compounds and polyamine compounds as well as ascorbic acid and thiourea dioxide. Reduction sensitization can also be achieved by ripening a silver halide emulsion, while maintaining the emulsion at a pH of 7 or more, or at a pAg of 8.3 or less. Reduction sensitization can also be performed by introduction of a single addition of silver ions during grain formation.

Subsequently, other constituent elements of the photothermographic material of the invention will be further described.

The photothermographic material comprises on a support a light sensitive layer containing an organic silver salt, as described above, light-sensitive silver halide and a reducing agent and a protective layer in this order set forth. Further, an interlayer may optionally be provided between the light-sensitive layer and the protective layer.

In order to secure transportability or to prevent blocking onto the protective layer, a backing layer may be provided on the opposite side of the support to the light-sensitive layer. The respective layers described above, each may comprises a single layer or different two or more layers.

Preferably, a binder resin is employed to form each of the above-mentioned layers. The binder resin can be chosen from conventionally used transparent or translucent binder resins. Examples of such binder resins include polyvinyl acetal resin such as polyvinyl formal, polyvinyl acetoacetal or polyvinyl butyral; cellulose resin such as ethyl cellulose, hydroxyethyl cellulose or cellulose acetobutyrate; styrene resin such as polystyrene, styrene/acrylonitrile copolymer or styrene/acrylonitrile/acryl rubber copolymer; vinyl chloride resin such as polyvinyl chloride or poly(chlorinated propylene); polyester; polyurethane; polycarbonate; polyallyrate, epoxy resin and acryl resin. The resin may be used singly or in combination thereof.

The above-mentioned binder resin may appropriately be used in the protective layer, the interlayer or an optional backing layer. In the interlayer or backing layer, an epoxy resin or acryl monomer capable of polymerizing upon exposure to actinic rays may be used as a layer-forming binder resin. In the invention, aqueous-based binder resins described below is also preferable. Thus, a water-soluble polymer or water-dispersible hydrophobic polymer (latex) is usable. Examples thereof include polyvinylidene chloride, vinylidene chloride/acrylic acid copolymer, vinylidene chloride/itaconic acid copolymer, poly(sodium acrylate), polyethylene oxide, acrylic acid amide/acrylic acid ester copolymer, styrene/maleic acid anhydride copolymer, acrylonitrile/butadiene copolymer, vinyl chloride/vinyl acetate copolymer and styrene/butadiene/acrylic acid copolymer. These constitute a water-based coating solution, which is coated and dried to form a uniform resin layer. The foregoing polymer is used, for example, in such a manner that an aqueous dispersion comprised of an organic silver salt, silver halide, reducing agent and the like is mixed with the polymer (latex) and the obtained dispersion is coated and dried to form a thermally developable light-sensitive layer. Drying melts particulate latex to form a uniform layer. The polymer preferably exhibits a glass transition point of −20 to 80° C., and more preferably −5 to 60° C. A higher glass transition temperature results in a rise in thermal development temperature and a lower glass transition point often causes fogging, resulting in reduced sensitivity or a decrease in contrast. An aqueous polymer dispersion is preferably comprised of particles having an average particle size of 1 nm to several μms. A water-dispersible hydrophobic polymer is generally called a latex, which is preferably used as a binder for water-based paints in terms of enhanced water resistance. The amount of latex to achieve water resistance as a binder is determined by taking into account coatability, but the more is more preferred in terms of moisture resistance. The weight ratio of latex to the total binder is preferably 50% to 100%, and more preferably 80% to 100%.

The binder content is preferably 0.25 to 10 times the silver coverage, for example, when the silver coverage is 2.0 g/m², the polymer coverage is preferably 0.5 to 20 g/m². More preferably, the binder content is 0.5 to 7 times silver coverage and, for example, when the silver coverage is 2.0 g/m², the polymer coverage is more preferably 1.0 to 14 g/m². A binder content of less than 0.25 times the silver coverage often markedly deteriorates silver image color to a level unacceptable to practice, and a binder content of more than 10 times the silver coverage results in a decrease in contrast to a level unacceptable in practice.

In addition to the above-mentioned essential constituents and binder resin, the light-sensitive layer may optionally contain additives such as an antifoggant, an image toning agent, a sensitizing dye and supersensitizing material (also called supersensitizer).

Antifoggants are appropriately chosen, including, for example, a heterocyclic compound containing at least one substituent represented by formula of —C(X1)(X2)(X3) in which X1 and X2 are each a halogen atom and X3 is a hydrogen atom or a halogen atom, as described in U.S. Pat. Nos. 3,874,946 and 4,756,999 and compounds described in JP-A Nos. 9-288328 and 9-90550; and U.S. Pat. No. 5,028,523 and European patent Nos. 600,587, 605,981 and 631,176. The content is preferably 0.25 to 10 times silver coverage, for example, when the silver coverage is 2.0 g/m², the polymer coverage is preferably 0.5 to 20 g/m².

Examples of an image toning agent to modify image color include imides (e.g., phthalimide), cyclic imides, pyrazoline-5-ones, quinazoline (e.g., succimide, 3-phenyl-2-pyrazoline-5-one, 1-phenylurazole, quinazoline, 2,4-thiazolidine-one); naphthalimides (e.g., N-hydroxy-1,8-naphthalimide); cobalt complexes (e.g., hexaaminetrifluoroacetate of cobalt), mercaptans (e.g., 3-mercapto-1,2,4-triazole); N-(aminomethyl)aryldicarboxyimides (e.g., N-(dimethylaminomethyl)phthalimisw); blocked pyrazoles, isothiuronium derivatives and their combination with some light-bleaching agents (e.g., N,N′-hexamethylene(1-carbamoyl-3,5-dimethylpyrazole), 1,8-(3,6-dioxaoctane)bis(isothiuroniumtrifluoroacetate) and its combination with 2-(tribromomethylsulfonium)benzothiazole), merocyanine dyes (e.g., 3-ethyl-5-((3-ethyl-2-benzothiazolinilydene(benzothiazolinidene)-2-thio-2,4-oxazolidinedione); phthalazine, phthalazine derivatives and their metal salts (e.g., 4-(1-naphthyl)phthalazinone, 6-chlorophthalazinone, 5,7-dimethyloxyphthalazinone, 2,3-dihydroxy-1,4-phthalazinedione); combination of phthalazinone and sulfinic acid derivatives (e.g., 6-chlorophthalazinone+benzenesulfinic acid sodium salt, 8-methylphthalzinone+p-trisulfonic acid soldium salt); combination of phthalazine and phthalic acid; combination of phthalazines (including phthalazine adduct) and at least one selected from maleic acid anhydride, phthalic acid, 2,3-naphthalenedicarboxylic acid and o-phenylenic acid derivative or its anhydride (e.g., phthalic acid, 4-methylphthalic acid, 4-nitrophthalic acid, tetrachlorophthalic acid anhydride);quinazolinediones, benzoxazine, orthoxazine derivatives; benzoxazine-2,4-diones (e.g., 1,3-benzoxazine-2,40dione); pyrimidines and asymmetric triazines (e.g., 2,4-dihydroxypyrimidine), and tetraazapentalene derivatives (e.g., 3,6-dimercapto-1,4-diphenyl-1H, 4H-2,3a, 5,6a-tetrazapentalene). Preferred image toning agents are phthalazone and phthalzine. The image toning agent may be incorporated to a protective layer within the range not vitiating the effect of the invention.

Sensitizing dyes are chosen for various light sources, for example, simple merocyanine dyes described in JP-A Nos. 60162247 and 2-48635, U.S. Pat. No. 2,161,331, West German Patent No. 936,071 and JP-A No. 5-11389 for an argon ion laser light source; trinucleus cyanine dyes described in JP-A Nos. 50-62425, 54-18726 and 59-102229, specifically merocyanine dyes described in JP-A No. 7-287338 for a helium neon laser light source; thiacarbocyanine dyes described in JP-B Nos. 48-42172, 51-9609 and 55-39818 and JP-A No. 62-284343 and 2-105135 for LED and infrared semiconductor laser light sources; tricarbocyanine dyes described in JP-A Nos. 59-191032 and 60-80841 and 4-quinoline nucleus containing dicarbocyanine dye of formulas (IIIa) and (IIIb) described in JP-A Nos. 59-192242 and 3-67242 for infrared semiconductor laser light sources.

Further, the sensitizing dyes described in JP-A Nos. 4-182639 and 5-341432, JP-B Nos. 6-52387 and 3-10931, U.S. Pat. No. 5,441,866 and JP-A No. 7-13295 are preferred for infrared laser light sources of from 750 or more (preferably 800 nm or more).

Supersensitizers are chosen from those described in RD17643, JP-B Nos. 9-155000 and 43-4933 and JP-A 59-19032, 59-192242 and 5-341432. In the invention, an aromatic heterocyclic mercapto compound represented by the following formula (M) and disulfide compound represented by the following formula (Ma) which substantially release the foregoing mercapto compound are usable as a supersensitizer:
Ar—SM formula (M)
Ar—S—S—Ar formula (Ma)
In formula (M), M is a hydrogen atom or an alkali metal atom; Ar is an aromatic ring or condensed aromatic ring containing a nitrogen atom, oxygen atom, sulfur atom, selenium atom or tellurium atom. Such aromatic heterocyclic rings are preferably benzimidazole, naphthoimidazole, benzthiazole, naphthothiazole, benzoxazole, naphthooxazole, benzoselenazole, benzotellurazole, imidazole, oxazole, pyrazole, triazole, triazines, pyrimidine, pyridazine, pyrazine, pyridine, purine, and quinoline. Other aromatic heterocyclic rings may also be included. In formula (Ma), Ar is the same as defined in formula (M).

The aromatic heterocyclic rings described above may be substituted with a halogen atom (e.g., Cl, Br, I), a hydroxy group, an amino group, a carboxy group, an alkyl group (having one or more carbon atoms, and preferably 1 to 4 carbon atoms) or an alkoxy group (having one or more carbon atoms, and preferably 1 to 4 carbon atoms). The supersensitizer is incorporated into a light-sensitive layer containing organic silver salt and silver halide grains, preferably in an amount of 0.001 to 1.0 mol, and more preferably 0.01 to 0.5 mol per mol of silver.

A heteroatom containing a macrocyclic compound may be incorporated in the light-sensitive layer. At least a 9-membered macrocyclic compound containing at least a heteroatom selected from nitrogen, oxygen, sulfur and selenium atoms is preferred, 12- to 24-membered one is more preferred and a 15- to 21-membered one is still more preferred.

Representative compounds are crown ethers, which were synthesized by C. J. Pederson in 1967. Since then, a number of compounds were synthesized. These compounds are described in C. J. Pederson, Journal of American Chemical Society vol. 86, (2495), 7017-7036 (1967); G. W. Gokel, S. H. Korzeniowski, “Macrocyclic Polyether Synthesis” Springer-Verlag (1982).

In addition to the above-mentioned additives, for example, a surfactant, an antioxidant, a stabilizer, a plasticizer, UV absorber and a coating aid may be incorporated to the light-sensitive layer. Additives including the above-mentioned ones are described in RD17029 (1978, June, pages 9-15).

The light-sensitive layer may be composed of a single layer or different plural layers having the same composition. The light-sensitive layer is usually 10-30 μm thick.

In the photothermographic material of the invention, to control the amount or wavelength distribution of light transmitting the light-sensitive layer, a filter layer may be provided on the light-sensitive layer side or on the opposite side thereto, or a dye or a pigment may be incorporated in the light-sensitive layer.

Commonly known compounds which are capable of absorbing light in the various wavelength region in accordance with spectral sensitivity of the photothermographic material, are usable as a dye usable in the invention. For example, when the photothermographic material is used as an image recording material utilizing infrared radiation, it is preferable to employ squalilium dyes having a thiopyrylium nucleus (hereinafter referred to as thiopyriliumsqualilium dyes) and squalilium dyes having a pyrylium nucleus (hereinafter referred to as pyryliumsqualilium dyes), as described in Japanese Patent Application No. 11-255557, and thiopyryliumcroconium dyes or pyryliumcroconium dyes which are analogous to the squalilium dyes. Incidentally, the compounds having a squalilium nucleus, as described herein, refers to ones having 1-cyclobutene-2-hydroxy-4-one in their molecular structure. Herein, the hydroxyl group may be dissociated.

A support and a protective layer which are essential for layer constitution of the photothermographic material will be described in the following.

Resin film of, for example, poly(acrylic acid ester), poly(methacrylic acid ester), polyethylene terephthalate, polybutylene terephthalate, polyethylene naphthalate, polycarbonate, polyacrylate, polyvinyl chloride, polyethylene, polypropylene, polystyrene, nylon, poly(aromatic amide), polyether ether ketone, polysulfone, polyether sulfone, polyimide, poly(ether imide), or triacetyl cellulose is used as a support of the photothermographic material. Multilayer film of the foregoing resin is also usable.

In the image recording process related to the invention, after formation of latent image, the support is subjected to thermal development to form images, so that stretched and heat-set film is preferable in terms of dimensional stability. Fillers such as titanium oxide, zinc oxide, barium sulfate or calcium carbonate may be incorporated within a range not to inhibit effects of the invention. The support thickness is usually 10 to 500 μm, and preferably 25 to 250 μm.

Binder resin described in the afore-mentioned light-sensitive layer may optionally be employed in the protective layer of the photothermographic material.

With respect to additives in the protective layer, incorporation of fillers is preferable for scratch prevention of an image after thermal development or to maintain transportability. A filler is incorporated preferably in an amount of 0.05% to 30% by weight of the layer-forming composition.

In order to improve lubrication or antistatic properties, lubricants or antistatic agents may be incorporated into the protective layer. Examples of a lubricant include a fatty acid, fatty acid ester, fatty acid amide, polyoxyethylene, polyoxypropylene, (modified) silicone oil, (modified ) silicone resin, fluororesin, fluorinated carbon and wax. Examples of an antistatic agent include a cationic surfactant, anionic surfactant, nonionic surfactant, polymeric antistatic agent, metal oxide, conductive polymer, compounds described in “11290 Chemical Products” Kagaku Kogyo Nippo-sha, page 875-876, and compounds described in U.S. Pat. No. 5,244,773, col. 14-20. Various additives for the light-sensitive layer may be incorporated into the protective layer within the range not to inhibit advantageous effects of the invention. Such additives are incorporated preferably in an amount of 0.01% to 20% by weight of the protective layer composition, and more preferably 0.05% to 10%. The protective layer may be a single layer or composed of plural layers which are different or identical in composition. The protective layer thickness is preferably 1.0 to 5.0 μm.

In addition to the above-mentioned light-sensitive layer, support and protective layer, there may be provided an interlayer for improvement of adhesion of the light-sensitive layer onto the support or a backing layer for the purpose of enhancing transportability or preventing static electricity. The interlayer thickness is preferably from 0.05 to 2.0 μm and the backing layer thickness is preferably from 0.1 to 10 μm.

A coating solution for the light-sensitive layer, a coating solution for the protective layer and a coating solution for an interlayer or backing layer to be optionally provided are each prepared by dissolving or dispersing the respective constituents described above in an appropriate solvent.

There may be usable any solvent which exhibits a solubility parameter of 6.0 to 15.0, as described in “Yozai Pocket Book” (Solvent Pocket Book), edited by Yukigosei Kagaku Kyokai. Examples of such a solvent usable in the foregoing coating solutions include ketones such as acetone, isophorone, ethyl amyl ketone, methyl ethyl ketone and methyl isobutyl ketone; alcohols such as methyl alcohol, ethyl alcohol, n-propyl alcohol, isopropyl alcohol, n-butyl alcohol, isobutyl alcohol, diacetone alcohol, cyclohexanol and benzyl alcohol; glycols such as ethylene glycol, diethylene glycol, triethylene glycol, propylene glycol, and hexylene glycol; ether alcohols such as ethylene glycol monomethyl ether and diethylene glycol monoethyl ether; ethers such as ethyl ether, dioxane, and isopropyl ether; esters such as ethyl acetate, butyl acetate, amyl acetate and isopropyl acetate; hydrocarbons such as n-pentane, n-hexane, n-heptane, cyclohexane, benzene, toluene and xylene; chlorides such as methyl chloride, chloromethylene, chloroform and dichlorobenzene. These solvents may be used singly or in combinations thereof. The residual solvent amount in the photothermographic material can be controlled by optimally setting temperature conditions in the stage of drying after coating. The overall residual solvent amount is preferably from 5 to 1,000 mg/M² and more preferably 10 to 300 mg/m².

When dispersing is needed in the preparation of the respective coating solutions, commonly known dispersing machines are usable, such as a two-roll mill, a three-roll mill, a ball mill, a pebble mill, a cobol mill, a trone mill, a sand grinder, Sqegvari atriter, a high-speed impeller dispersing machine, a high-speed stone mill, a high-speed impact mill, disper, a high-speed mixer, homogenizer, an ultrasonic dispersing machine, an open kneader or a continuous kneader.

The respective coating solutions can be coated by using commonly known coaters, for example, an extrusion coater, a reverse roll coater, a gravure coater, an air-doctor coater, a blade coater, an air-knife coater, a squeeze coater, a dip coater, a bar coater, a transfer roll coater, a kiss coater, a cast coater and a spray coater. Of these coaters, to minimize unevenness in coated layer thickness, an extrusion coater or a roll coater, for example, a reverse roll coater is preferred.

Any protective layer is applicable if it causes no damage to the light-sensitive layer. In cases when a solvent contained in a coating solution of the protective layer possibly dissolves the light-sensitive layer, using an extrusion coater or a gravure roll coater is preferred. When using a contact-coating method such as a gravure roll coater or a bar coater, the direction of rotation of a gravure roll or a bar may be normal rotation or reverse rotation to the direction of travel. In the case of normal rotation, it may be equal or different in circumferential speed.

To form the respective constituent layers, coating and drying may be repeated for each of the layer. Alternatively, simultaneous multilayer coating is performed in a wet-on-wet system, followed by being dried, in which coating is performed by the combination of an extrusion coater with a reverse roll coater, a gravure roll coater, an air doctor coater, a blade coater, an air knife coater, a squeeze coater, a dip coater, a bar coater, a ransfer roll coater, a kiss coater, a st coater or a spray coater. In the simultaneous multilayer coating in a wet-on-wet system, the upper layer is coated on the lower layer in a wet state, thereby resulting in enhanced adhesion between the upper and lower layers.

After coating a coating solution of the light-sensitive layer, the coated layer is dried preferably at a temperature of from 65 to 100° C. to achieve an object of the invention. A drying temperature of less than 65° C. leads to incomplete reaction and aging change in sensitivity often results. A drying temperature of more than 100° C. often causes fogging (coloring) in a photothermographic material immediately after preparation. The drying, depending on the air quantity during drying, is preferably within the range of 2 to 30 min. Immediately after coating, drying may be conducted at a temperature within the range described above. Alternatively, to prevent unevenness (yuzu orange skin) caused by Marangoni effect of a coating solution in drying or caused by the surface being initially dried by hot air, the initial drying is conducted at a temperature lower than 65° C., followed by drying at a temperature within the above-described range.

The photothermographic material of the invention and a suitable preparation method thereof can realize the object of the invention. Further, optimization of an image forming method can obtain clear images without causing interference fringes.

Subsequently, an image recording method suitable for the photothermographic material of the invention will be described below.

The image recording method applicable in the invention is mainly divided to three embodiments according to the angle between the exposed surface and laser beam, the wavelength of laser and the number of lasers and may be performed by a single embodiment thereof or the combination of two or more embodiments. Performing such a image recording method can obtain a clear image having no interference fringe.

In one suitable embodiment of the image recording method of the invention, image formation is performed by scanning exposure using a laser light in which the angle between the surface of a photothermographic material and the laser beam does not substantially become vertical. Deviating the incident light angle from the verticality of laser beam incident angle increases an optical path difference at the light-sensitive layer and even when reflection light is produced at the interface between layers, scattering or attenuation occurs in the optical path of laser light, rendering it difficult to cause interference fringes. “Does not substantially become vertical”, as described herein, means that during laser scanning, the nearest vertical angle is preferably from 55 to 88 degrees, is more preferably from 60 to 86 degrees, and is still more preferably from 65 to 84 degrees.

In further preferred embodiment of the image recording method, image formation is performed by scanning exposure using laser beam in a longitudinal multiple mode in which the exposure wavelength is not single. Scanning by using laser beam in a longitudinal multiple mode having a width in exposure wavelength reduces generation of interference fringes, as compared to scanning laser light of a longitudinally single mode. The longitudinal multiple mode, as described herein, means that the wavelength of radiation employed for exposure is not single. The wavelength distribution of the radiation is commonly at least 5 nm, and is preferably at least 10 nm. The upper limit of the wavelength of the radiation is not particularly limited, but is commonly about 60 nm.

In the image recording method related to the invention, lasers usable in the scanning exposure include, for example, a solid laser such as a ruby laser, YAG laser or glass laser; a gas laser such as He-Ne laser, Ar laser, Kr laser, CO₂ laser, CO laser, He-Cd laser, N₂ laser or excimer laser: a semiconductor laser such as InGaP laser, AlGaAs laser, GaAsP laser, InGaAs laser, InAsP laser, CdSnP₂ laseror GaSb laser; a chemical laser and a dye laser. These are appropriately chosen according to the use thereof but in the image recording method related to the invention, a semiconductor laser having a wavelength of 600 to 1200 nm is preferred in terms of maintenance and size of a light source.

When scanned on a photothermographic material using a laser imager or a laser image setter, the beam diameter on the exposed surface of the photothermographic material is usually from 5 to 75 μm and the minor axis and the main axis diameter are from 5 to 75 μm and from 5 to 100 μm, respectively. The laser light scanning speed can be optimally set for every photothermographic material, according to the sensitivity of the photothermographic material at a laser oscillating wavelength and the laser power.

Synthesis of the bisphenol compounds of the invention will be described below but other synthesis methods are also applicable.
Synthesis of Compound D-21: 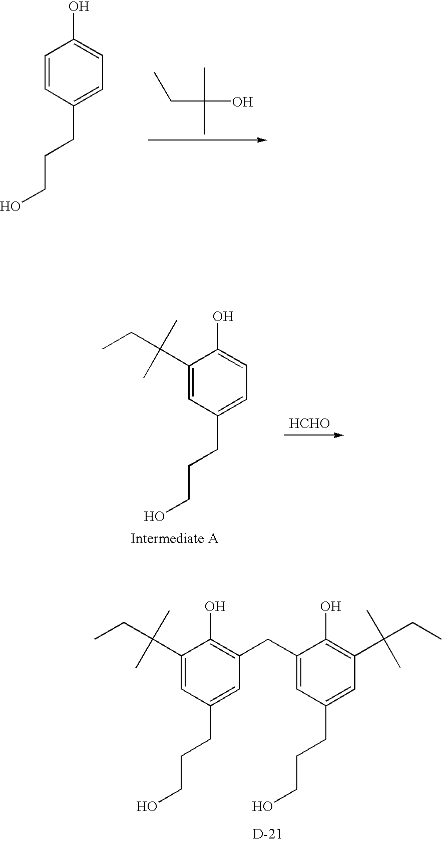
Synthesis of Intermediate A:

In 300 ml of toluene was dissolved 85 g of 3-(p-hydroxyphenyl)-1-propanol and 100 g of an aqueous 85% phosphoric acid solution was further added thereto. The reaction mixture was heated to 100° C. 54 g of tert-pentanol was dropwise added over 40 min. After completing addition, the reaction mixture was stirred at 100° C. for 2 hr. and then, 10 g of tert-pentanol was added thereto. After further stirring at 100° C. for 1 hr., the reaction mixture was allowed to stand until being cooled to room temperature. To the reaction mixture were successively added 1 liter of ethyl acetate and 200 ml of saturated sodium chloride solution with stirring, then, an organic layer was separated therefrom. After washing the organic layer with water, the solvent was distilled under reduced pressure. The residue was purified in silica gel column chromatography to obtain 115 g of intermediate A

Synthesis of Exemplified Compound D-21:

In 200 ml of toluene was dissolved 60 g of intermediate A, then, 20 g of p-toluenesulfonic acid monohydrate and 4.5 g of paraformaldehyde was added thereto. The reaction mixture was heated to 75° C. and stirred for 2 hr. The reaction mixture was allowed to stand until cooled to room temperature and then, 100 ml of ethyl acetate was added and an organic layer was washed water. The solvent was distilled under reduced pressure and the residue was purified in silica gel column chromatography. The product was recrystallized in toluene to obtain 34 g of D-21. The melting point was 107.8° C. The structure was identified according to the following:

¹H-NMR (CDCl₃): δ=0.59 (t, 6H, CH₃), 1.33 (s, 12H, CH₃), 1.77-1.88 (m, 8H, CH₂), 2.60 (t, 4H, CH₂), 3.64 (t, 4H, CH₂), 3.88 (s, 2H, CH₂), 6.90 (s, 1H, CH), 6.95 (s, 1H,CH).

### EXAMPLES

The present invention is explained in more detail with reference to the following examples, but the present invention should not be construed as being limited thereto.

### Example 1

Preparation of Subbed Photographic Support:

Both surfaces of a commercially available biaxially stretched thermally fixed, blue-tinted 175 μm PET film, which exhibited an optical density of 0.170 (determined by densitometer PDA-65, produced by Konica Minolta Corp.), was subjected to corona discharging at 8 w/m²·min. Onto one side thereof, the subbing coating composition a-1 descried below was applied so as to form a dried layer thickness of 0.8 μm, which was then dried. The resulting coating was designated Subbing Layer A-1. Onto the opposite side, the subbing coating composition b-1 described below was applied to form a dried layer thickness of 0.8 μm. The resulting coating was designated Subbing Layer B-1.

Subbing coating composition a-1

| | | |
|---|---|---|
| Latex solution (solid 30%) of | 270 | g |
| a copolymer consisting of butyl acrylate | | |
| (30 weight %), t-butyl acrylate (20 weight %) | | |
| styrene (25 weight %) and 2-hydroxy | | |
| ethyl acrylate (25 weight %) | | |
| (C-1) | 0.6 | g |
| Hexamethylene-1,6-bis(ethyleneurea) | 0.8 | g |
| Water to make | 1 | liter |

Subbing coating composition b-1

| | | |
|---|---|---|
| Latex liquid (solid portion of 30%) | 270 | g |
| of a copolymer consisting of | | |
| butyl acrylate (40 weight %) | | |
| styrene (20 weight %) | | |
| glycidyl acrylate (25 weight %) | | |
| (C-1) | 0.6 | g |
| Hexamethylene-1,6-bis(ethyleneurea) | 0.8 | g |
| Water to make | 1 | liter |

Subsequently, the surfaces of Subbing Layers A-1 and B-1 were subjected to corona discharging with 8 w/m²·minute. Onto the Subbing Layer A-1, the upper subbing layer coating composition a-2 described below was applied so as to form a dried layer thickness of 0.8 μm, which was designated Subbing Layer A-2, while onto the Subbing Layer B-1, the upper subbing layer coating composition b-2 was applied so at to form a dried layer thickness of 0.8 μm, having a static preventing function, which was designated Subbing Upper Layer B-2.

| | |
|---|---|
| Upper subbing layer coating composition a-2 | |
| Gelatin in an amount (weight) to make | 0.4 g/m² |
| (C-1) | 0.2 g |
| (C-2) | 0.2 g |
| (C-3) | 0.1 g |
| Silica particles (av. size 3 μm) | 0.1 g |
| Water to make | 1 liter |
| Upper subbing layer coating composition b-2 | |
| (C-A) | 60 g |
| Latex solution (solid 20% comprising) | 80 g |
| (C-5) as a substituent | |
| Ammonium sulfate | 0.5 g |
| (C-6) | 12 g |
| Polyethylene glycol (average | 6 g |
| molecular weight of 600) | |
| Water to make | 1 liter |

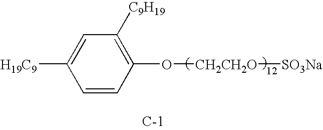

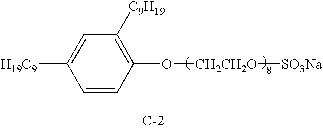

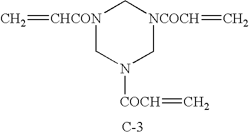

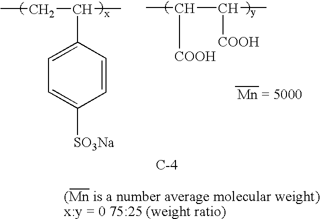

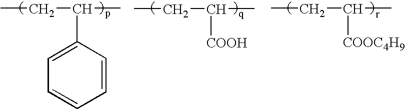

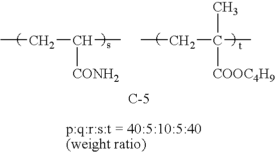

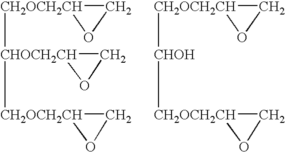

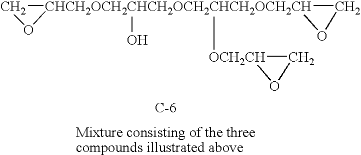

Preparation of Backing Layer Coating Solution

To 830 g of methyl ethyl ketone (MEK), 84.2 g of cellulose acetate-butyrate (CAB381-20, available from Eastman Chemical Co.) and 4.5 g of polyester resin (Vitel PE2200B, available from Bostic Corp.) were added with stirring and dissolved therein. To the resulting solution was added 0.0.57 mmol of infrared dye 1, then, 4.5 g fluorinated surfactant (Surflon KH40, available from ASAHI Glass Co. Ltd.) and 2.3 g fluorinated surfactant (Megafag F120K, available from DAINIPPON INK Co. Ltd.) which were dissolved in 43.2 g methanol, were added thereto and stirred until being dissolved. Then, 75 g of silica (Siloid 64X6000, available from W.R. Grace Corp.), which was dispersed in methyl ethyl ketone in a concentration of 1 wt % using a dissolver type homogenizer, was further added thereto with stirring to obtain a coating solution for the backing layer.

The thus prepared coating solution of the backing layer was coated using an extrusion coater and dried so as to have a dry thickness of 3.5 μm. Drying was conducted over 5 min. using hot air at a drying temperature of 100° C. and a dew point of 10° C.

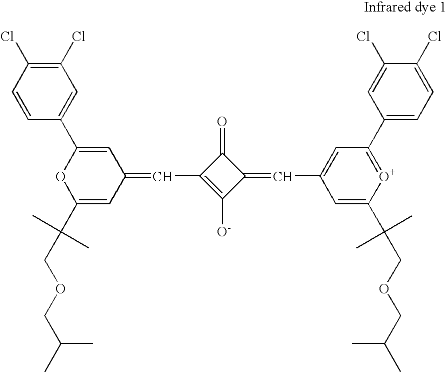

Preparation of Light-sensitive Silver Halide Emulsion A:

Solution A1

| | | |
|---|---|---|
| Phenylcarbamoyl gelatin | 88.3 | g |
| Compound (A) (10% methanol solution) | 10 | ml |
| Potassium bromide | 0.32 | g |
| Water to make | 5429 | ml |

Solution B1

| | | |
|---|---|---|
| 0.67 mol/l Aqueous silver nitrate solution | 2635 | ml |

Solution C1

| | | |
|---|---|---|
| Potassium bromide | 51.55 | g |
| Potassium iodide | 1.47 | g |
| Water to make | 660 | ml |

Solution D1

| | | |
|---|---|---|
| Potassium bromide | 154.9 | g |
| Potassium iodide | 4.41 | g |
| Iridium chloride (1% solution) | 0.93 | ml |
| Water to make | 1982 | ml |

Solution E1

0.4 mol/l aqueous potassium bromide solution
Amount necessary to adjust silver potential

Solution F1

| | | |
|---|---|---|
| Potassium hydroxide | 0.71 | g |
| Water to make | 20 | ml |

Solution G1

| | | |
|---|---|---|
| Aqueous 56% acetic acid solution | 18 | ml |

Solution H1

| | | |
|---|---|---|
| Anhydrous sodium carbonate | 1.72 | g |
| Water to make | 151 | ml |

Compound (A) HO(CH₂CH₂O)ₙ—(CH(CH₃)CH₂O)₁₇—(CH₂CH₂O)ₘH (m + n = 5 to 7)

Using a stirring mixer described in JP-B 58-58288 and 58-58289, ¼ of solution B1, the total amount of solution C1 were added to solution A1 by the double jet addition for 4 min 45 sec. to form nucleus grain, while maintaining a temperature of 450 C and a pAg of 8.09. After 1 min., the total amount of solution F1 was added thereto. After 6 min, ¾ of solution B1 and the total amount of solution D1 were further added by the double jet addition for 14 min 15 sec., while mainlining a temperature of 45° C. and a pAg of 8.09. After stirring for 5 min., the reaction mixture was lowered to 40° C. and solution G1 was added thereto to coagulate the resulting silver halide emulsion. Remaining 2000 ml of precipitates, the supernatant was removed and after adding 10 lit. water with stirring, the silver halide emulsion was again coagulated. Remaining 1500 ml of precipitates, the supernatant was removed and after adding 10 lit. water with stirring, the silver halide emulsion was again coagulated. Remaining 1500 ml of precipitates, the supernatant was removed and solution H1 was added. The temperature was raised to 60° c. and stirring continued for 120 min. Finally, the pH was adjusted to 5.8 and water was added there to so that the weight per mol of silver was 1161 g, and light-sensitive silver halide emulsion A was thus obtained. It was proved that the resulting emulsion was comprised of monodisperse silver iodobromide cubic grains having an average grain size of 0.058 μm, a coefficient of variation of grain size of 12% and a [100] face ratio of 92%.

To the obtained emulsion was added 240 ml of sulfur sensitizer S-5 (0.5% methanol solution), and a gold sensitizer Au-5 was further added thereto in an amount equivalent to 1/20 mol of the sulfur sensitizer and stirred for 120 min. at 55° C. to perform chemical sensitization.

Preparation of Powdery Organic Silver Salt A:

Behenic acid of 130.8 g, arachidic acid of 67.7 g, stearic acid of 43.6 g and palmitic acid of 2.3 g were dissolved in 4720 ml of water at 90° C. Then, 540.2 ml of aqueous 1.4 mol/l NaOH was added, and after further adding 6.9 ml of concentrated nitric acid, the mixture was cooled to 55° C. to obtain a fatty acid sodium salt solution. To the thus obtained fatty acid sodium salt solution, 45.3 g of light-sensitive silver halide emulsion B-3 obtained above and 450 ml of water were added and stirred for 5 min., while being maintained at 55° C. Subsequently, 760 ml of 1M aqueous silver nitrate solution was added in 2 min. and stirring continued further for 20 min., then, the reaction mixture was filtered to remove aqueous soluble salts. Thereafter, washing with deionized water and filtration were repeated until the filtrate reached a conductivity of 2 μS/cm. Using a flush jet dryer (produced by Seishin Kigyo Co., Ltd.), the thus obtained cake-like organic silver salt was dried under an atmosphere of inert gas (i.e., nitrogen gas) having a volume ratio shown in Table 1, according to the operation condition of a hot air temperature at the inlet of the dryer until reached a moisture content of 0.1%. The moisture content was measured by an infrared ray aquameter.

Preparation of Pre-dispersion A:

In 1457 g MEK was dissolved 14.57 g of polyvinyl butyral powder (B-79, available from Monsanto Co.) and further thereto was gradually added 500 g of powdery organic silver salt A to obtain pre-dispersion A, while stirring by a dissolver type homogenizer (DISPERMAT Type CA-40, available from VMA-GETZMANN).

Preparation of Light-sensitive Emulsion 1:

Thereafter, using a pump, the thus prepared pre-dispersion A was transferred to a media type dispersion machine (DISPERMAT Type SL-C12 EX, available from VMA-GETZMANN), which was packed 1 mm Zirconia beads (TORESELAM, available from Toray Co. Ltd.) by 80%, and dispersed at a circumferential speed of 8 m/s and for 1.5 min. of a retention time with a mill to obtain light-sensitive emulsion 1.

Preparation of Stabilizer Solution:

In 4.97 g of methanol were dissolved 1.0 g of Stabilizer 1 and 0.31 g of potassium acetate to obtain stabilizer solution.

Preparation of Infrared Sensitizing Dye Solution A:

In 31.3 g of MEK were dissolved 19.2 mg of infrared sensitizing dye 1, 1.488 g of 2-chlorobenzoic acid, 2.779 g of Stabilizer 2 and 365 mg of 5-methyl-2-mercaptobenzimidazole in a dark room to obtain an infrared sensitizing dye solution A.

Preparation of Additive Solution a:

In 110 g of MEK were dissolved reducing agents used as a developer (shown in Table 1), 1.54 g of 4-methylphthalic acid and 0.92 mmol of infrared dye 1 to obtain additive solution a.

Preparation of Additive Solution b:

In 40.9 g of MEK was dissolved in 3.56 g of antifoggant 2 and 3.43 g of phthalazinone to obtain additive solution b.

Preparation of Light-sensitive Layer Coating Solution:

Under inert gas atmosphere (97% nitrogen), 50 g of the light-sensitive emulsion 1 and 15.11 g MEK were maintained at 21° C. with stirring and 390 μl of antifoggant 1 (10% methanol solution) was added and stirred for 1 hr. Further thereto, 494 μl of calcium bromide (10% methanol solution) was added and stirred for 20 min. Subsequently, 167 ml of the stabilizer solution was added and after stirring for 10 min., 1.32 g of the infrared sensitizing dye solution was added and stirred for 1 hr. Then, the mixture was cooled to 13° C. and stirred for 30 min. Further thereto, 13.31 g of polyvinyl butyral (Butvar B-79, available from Monsanto Co.) was added and stirred for 30 min, while maintaining the temperature at 13° C., and 1.084 g of tetrachlorophthalic acid (9.4 wt % MEK solution) and stirred for 15 min. Then, 12.43 g of additive solution a, 1.6 ml of 10% MEK solution of Desmodur N3300 (aliphatic isocyanate, product by Movey Co.) and 4.27 g of additive solution b were successively added with stirring to obtain coating solution of the light-sensitive layer.
Comparative Reducing Agents: 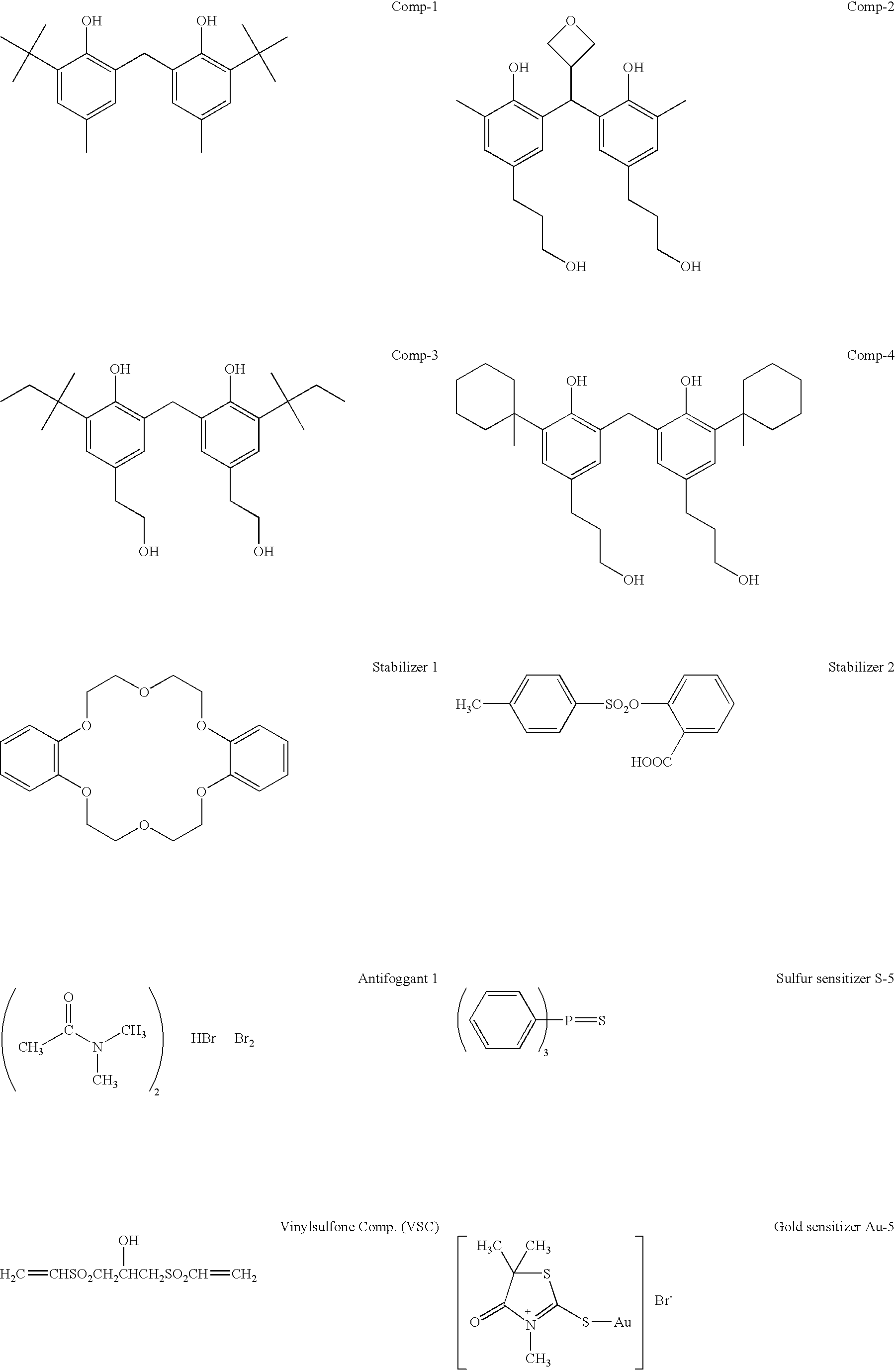 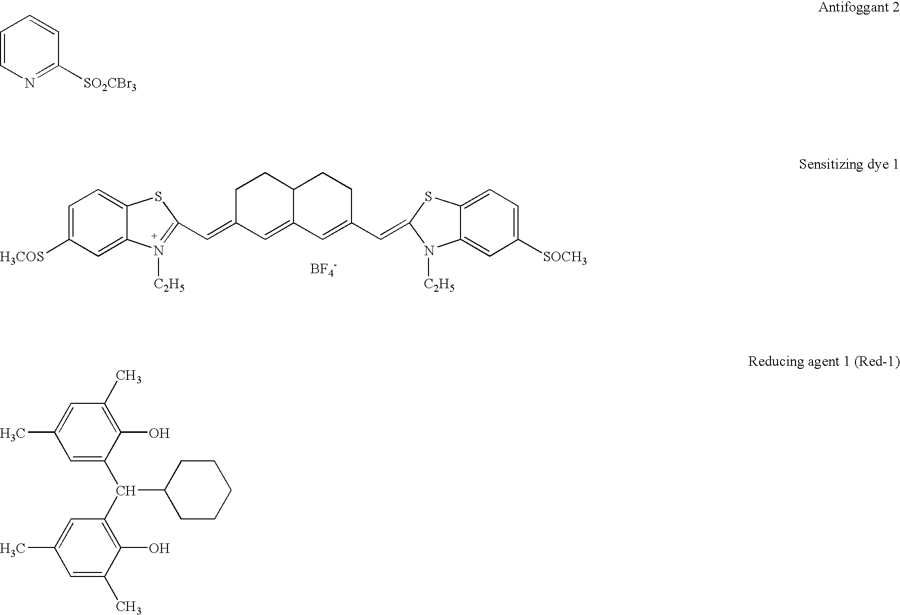
Preparation of Matting Agent Dispersion:

In 42.5 g methyl ethyl ketone was dissolved 7.5 g of cellulose acetate-butyrate (CAB171-15, available from Eastman Chemical Co.) and then 5 g of calcium carbonate (Super-Pflex 200, available from Speciality Mineral Corp.) was added thereto and dispersed using a dissolver type homogenizer at a speed of 800 rpm over a period of 30 min. to obtain calcium carbonate dispersion.

Preparation of Coating Solution for Protective Layer:

To 865 g of methyl ethyl ketone were added with stirring 96 g of cellulose acetate-butyrate (CAB171-15, available from Eastman Chemical Co.) and 4.5 g of polymethyl methacrylate (Paraloid A-21, available from Rohm & Haas Corp.). Further thereto were added and dissolved 1.5 g of vinylsulfon compound HD-1, 1.0 g of benzotriazole and 1.0 g of fluorinated surfactant (Surflon KH40, available from ASAHI Glass Co. Ltd.). Finally, 30 g of the foregoing matting agent dispersion was added and stirred to obtain a coating composition for the surface protective layer.

Coating of Light-sensitive Layer Side:

The foregoing light-sensitive layer coating composition and protective layer coating composition were simultaneously coated by using an extrusion coater so that the silver coverage of the light-sensitive layer was 1.9 g/m² and dry thickness of the protective layer was 2.5 μm. Thereafter, drying was conducted using hot-air at a dry-bulb temperature of 75° C. and a dew point of 10° C. over a period of 10 min to obtain a coated sample (photothermographic material).

Exposure and Processing:

Photothermographic material samples which were aged at 23° C. for 120 hr (denoted as aging condition A) and samples which were aged in an incubator at 50° C. and 55% RH for 120 hr. (denoted as aging condition B), were each subjected to laser scanning exposure from the protective layer side by an exposure machine using a semiconductor laser at a wavelength of 785 nm as a light source. Exposure was performed at an angle of 75 degrees between the exposed surface of photothermographic material and a laser beam.

Subsequently, these samples were thermally developed at 123° C. for 12.5 sec. (denoted as processing condition 1) or at 123° C. for 8 sec. (denoted as processing condition 2, using an automatic processor provided with a heat drum. Exposure and development were conducted in a room conditioned at 23° C. and 50% RH. The thus exposed and thermally developed samples were each evaluated as follows.

Fogging:

The visual transmission density of an unexposed area was measured at 5 points using a densitometer (color transmission densitometer 310T, produced by X-Rite Co.) and the average value thereof was evaluated as the fog density (denoted as Fog).

Maximum Density:

The visual transmission density of a maximum density area was measured at 3 points using a densitometer (color transmission densitometer 310T, produced by X-Rite Co.) and the average value thereof was evaluated as the maximum density (denoted as Dmax). Maximum densities of samples were represented by a relative value, based on the maximum density being 100 of sample No. 1 which was aged under aging condition A and processed in processing condition 1.

Silver Image Storage Stability:

One of two sheets of a sample which was processed similarly to sensitometry, as described above, was aged at 25° C. and 55% RH for 7 days while being light-shielded, and the other one was aged at 25° C. and 55% RH for 7 days while being exposed to natural light. Densities of the fogged area of both aged samples were measured, and an increase of fog density (denoted as fog increase 1) was determined based on the following equation to evaluate storage stability of silver images (also denoted as image stability):
Fog increase 1=(fog density when aged while being exposed to natural light)−(fog density when aged while being light-shielded).
Silver Image Color

A density area exhibiting a transmission density of 1.1±0.05 was visually observed and evaluated with respect to silver image color (tone), based on the following criteria:
5: it was neutral black tone and no yellowish tone was observed,
4: it was not neutral black but yellowish tone was scarcely observed,
3: a slightly yellowish tone was partially observed,
2: a slightly yellowish tone was overall observed,
1: a yellowish tone was apparently observed.

In the foregoing, an evaluation of “4” or more represented no problem in quality assurance and was acceptable in practice.

TABLE 1

| | Reducing Agent | | | | | | | Silver | |
|---|---|---|---|---|---|---|---|---|---|
| Sample | Compound | Compound | | | | | Image | Image | |
| No. | (mmol) | (mmol) | Aging | Processing | Fog | Dmax | Stability | Color | Remark |
| 1 | Comp-1(82.6) | — | A | 1 | 0.27 | 100 | 0.20 | 1 | Comp. |
| 2 | Comp-2(82.6) | — | A | 1 | 0.17 | 70 | 0.15 | 3 | Comp. |
| 3 | Comp-3(82.6) | — | A | 1 | 0.18 | 80 | 0.05 | 2 | Comp. |
| 4 | Comp-4(82.6) | — | A | 1 | 0.17 | 102 | 0.03 | 3 | Comp. |
| 5 | Comp-1(82.6) | — | B | 1 | 0.40 | 95 | 0.20 | 1 | Comp. |
| 6 | Comp-2(82.6) | — | B | 1 | 0.19 | 60 | 0.15 | 3 | Comp. |
| 7 | Comp-3(82.6) | — | B | 1 | 0.21 | 90 | 0.06 | 2 | Comp. |
| 8 | Comp-4(82.6) | — | B | 1 | 0.19 | 95 | 0.03 | 3 | Comp. |
| 9 | Comp-1(82.6) | — | A | 2 | 0.22 | 95 | 0.21 | 1 | Comp. |
| 10 | Comp-2(82.6) | — | A | 2 | 0.17 | 50 | 0.17 | 3 | Comp. |
| 11 | Comp-3(82.6) | — | A | 2 | 0.28 | 70 | 0.07 | 3 | Comp. |
| 12 | Comp-4(82.6) | — | A | 2 | 0.17 | 100 | 0.04 | 3 | Comp. |
| 13 | Comp-1(57.8) | — | A | 2 | 0.21 | 90 | 0.20 | 1 | Comp. |
| 14 | Comp-2(57.8) | — | A | 2 | 0.27 | 30 | 0.13 | 3 | Comp. |
| 15 | Comp-1(41.3) | Red-1(41.3) | B | 2 | 0.31 | 85 | 0.19 | 1 | Comp. |
| 16 | Comp-4(41.3) | Red-1(41.3) | B | 2 | 0.17 | 90 | 0.02 | 4 | Comp. |
| 17 | D-1(82.6) | — | A | 1 | 0.16 | 110 | 0.02 | 4 | Inv. |
| 18 | D-1(82.6) | — | B | 1 | 0.17 | 109 | 0.02 | 4 | Inv. |
| 19 | D-1(57.8) | — | A | 2 | 0.15 | 102 | 0.02 | 4 | Inv. |
| 20 | D-1(41.3) | Red-1(41.3) | B | 2 | 0.17 | 103 | 0.03 | 5 | Inv. |
| 21 | D-3(57.8) | — | A | 2 | 0.16 | 100 | 0.03 | 4 | Inv. |
| 22 | D-15(57.8) | — | A | 2 | 0.16 | 103 | 0.03 | 5 | Inv. |
| 23 | D-16(57.8) | — | A | 2 | 0.17 | 104 | 0.03 | 4 | Inv. |
| 24 | D-21(82.6) | — | A | 1 | 0.15 | 115 | 0.03 | 5 | Inv. |
| 25 | D-21(82.6) | — | B | 1 | 0.16 | 113 | 0.03 | 5 | Inv. |
| 26 | D-21(57.8) | — | A | 2 | 0.15 | 110 | 0.01 | 5 | Inv. |
| 27 | D-21(41.3) | Red-1(41.3) | B | 2 | 0.16 | 107 | 0.02 | 5 | Inv. |
| 28 | D-23(82.6) | — | A | 2 | 0.16 | 113 | 0.02 | 5 | Inv. |
| 29 | D-23(57.8) | — | B | 2 | 0.17 | 108 | 0.02 | 5 | Inv. |
| 30 | D-43(57.8) | — | A | 2 | 0.17 | 110 | 0.02 | 4 | Inv. |
| 31 | D-48(82.6) | — | A | 2 | 0.16 | 100 | 0.03 | 4 | Inv. |
| 32 | D-51(57.8) | — | A | 2 | 0.15 | 105 | 0.02 | 5 | Inv. |
| 33 | D-64(82.6) | — | A | 2 | 0.16 | 100 | 0.03 | 4 | Inv. |
| 34 | D-88(57.8) | — | A | 2 | 0.16 | 107 | 0.02 | 5 | Inv. |

As apparent from Table 1, it was proved that the use of compounds of formula (1) as a reducing agent resulted in superior raw stock stability as well as reduced fogging and improved storage stability of silver images, and achieving a high maximum density and superior silver image color even in thermal development for a short time.

### Example 2

Photothermographic material samples were prepared similarly to Example 1, except that infrared dye 1 was replaced by infrared dye 2.

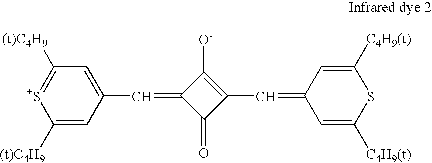

The prepared samples were exposed and processed similarly to Example 1, except that 785 nm semiconductor laser as a light source was replaced by 810 nm semiconductor laser. The thus processed samples were also evaluated similarly to Example 1. Results thereof are shown in Table 2.

TABLE 2

| | Reducing Agent | | | | | | | Silver | |
|---|---|---|---|---|---|---|---|---|---|
| Sample | Compound | Compound | | | | | Image | Image | |
| No. | (mmol) | (mmol) | Aging | Processing | Fog | Dmax | Stability | Color | Remark |
| 1 | Comp-1(57.8) | — | A | 1 | 0.25 | 100 | 0.17 | 1 | Comp. |
| 2 | Comp-2(57.8) | — | A | 1 | 0.16 | 50 | 0.10 | 3 | Comp. |
| 3 | Comp-3(57.8) | — | A | 1 | 0.17 | 70 | 0.04 | 2 | Comp. |
| 4 | Comp-4(57.8) | — | A | 1 | 0.16 | 100 | 0.03 | 3 | Comp. |
| 5 | Comp-1(57.8) | — | B | 1 | 0.38 | 85 | 0.20 | 1 | Comp. |
| 6 | Comp-2(57.8) | — | B | 1 | 0.18 | 40 | 0.15 | 3 | Comp. |
| 7 | Comp-3(57.8) | — | B | 1 | 0.20 | 60 | 0.06 | 2 | Comp. |
| 8 | Comp-4(57.8) | — | B | 1 | 0.18 | 90 | 0.03 | 3 | Comp. |
| 9 | Comp-1(57.8) | — | A | 2 | 0.20 | 95 | 0.21 | 1 | Comp. |
| 10 | Comp-2(57.8) | — | A | 2 | 0.16 | 30 | 0.17 | 3 | Comp. |
| 11 | Comp-3(57.8) | — | A | 2 | 0.27 | 60 | 0.07 | 3 | Comp. |
| 12 | Comp-4(57.8) | — | A | 2 | 0.16 | 97 | 0.03 | 3 | Comp. |
| 13 | Comp-1(41.3) | Red-1(41.3) | B | 2 | 0.30 | 85 | 0.19 | 1 | Comp. |
| 14 | ComP-4(41.3) | Red-1(41.3) | B | 2 | 0.17 | 90 | 0.02 | 4 | Comp. |
| 15 | D-1(57.8) | — | A | 1 | 0.15 | 108 | 0.02 | 4 | Inv. |
| 16 | D-1(57.8) | — | B | 1 | 0.16 | 108 | 0.02 | 4 | Inv. |
| 17 | D-1(57.8) | — | A | 2 | 0.15 | 100 | 0.02 | 4 | Inv. |
| 18 | D-1(41.3) | Red-1(41.3) | A | 2 | 0.16 | 105 | 0.02 | 5 | Inv. |
| 19 | D-3(57.8) | — | A | 2 | 0.16 | 101 | 0.03 | 4 | Inv. |
| 20 | D-15(57 8) | — | A | 2 | 0.16 | 102 | 0.02 | 5 | Inv. |
| 21 | D-16(57.8) | — | A | 2 | 0.16 | 103 | 0.03 | 4 | Inv. |
| 22 | D-21(57.8) | — | A | 1 | 0.15 | 110 | 0.02 | 5 | Inv. |
| 23 | D-21(57.8) | — | B | 1 | 0.15 | 109 | 0.02 | 5 | Inv. |
| 24 | D-21(57.8) | — | A | 2 | 0.15 | 108 | 0.01 | 5 | Inv. |
| 25 | D-21(41.3) | Red-1(41.3) | A | 2 | 0.16 | 107 | 0.02 | 5 | Inv. |
| 26 | D-23(57.8) | — | A | 2 | 0.15 | 110 | 0.02 | 5 | Inv. |
| 27 | D-23(57.8) | — | B | 2 | 0.16 | 106 | 0.02 | 5 | Inv. |
| 28 | D-43(57.8) | — | A | 2 | 0.16 | 108 | 0.02 | 4 | Inv. |
| 29 | D-48(82.6) | — | A | 2 | 0.15 | 100 | 0.03 | 4 | Inv. |
| 31 | D-64(82.6) | — | A | 2 | 0.15 | 100 | 0.03 | 4 | Inv. |

As apparent from Table 2, it was proved that even when exposed at a different wavelength, photothermographic materials according to the invention exhibited superior raw stock stability as well as reduced fogging and improved storage stability of silver images, and achieved a high maximum density and superior silver image color.

What is claimed is:

1. A photothermographic material comprising on at least one side of a support a light-sensitive layer containing a light-sensitive silver halide and a light-insensitive organic silver salt, wherein the photothermographic material further comprises at least a reducing agent represented by the following formula (1): 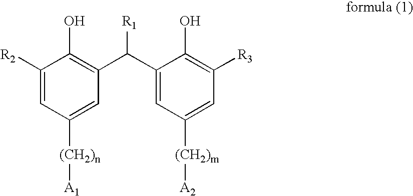
wherein R₁ is a hydrogen atom or a substituent; R₂ and R₃ are each independently a branched alkyl group having 3 to 6 carbon atoms; A₁ and A₂ are each independently a hydroxy group or a group capable of forming a hydroxy group upon deprotection; n and m are each an integer of 3 to 5.

2. The photothermographic material of claim 1, wherein in formula (1), A₁ and A₂ are each a hydroxy group.

3. The photothermographic material of claim 1, wherein in formula (1), A₁ and A₂ are each a group capable of forming a hydroxy group upon deprotection.

4. The photothermographic material of claim 1, wherein in formula (1), R₁ is a hydrogen atom, an alkyl group, a cycloalkyl group, an alkenyl group, an alkynyl, an aryl group, a heterocyclic group, a halogen atom or a cyano group.

5. The photothermographic material of claim 4, wherein R₁ is a hydrogen atom or an alkyl group.

6. The photothermographic material of claim 1, wherein in formula (1), R₂ and R₃ are each independently a tertiary alkyl group.

7. The photothermographic material of claim 6, wherein R₂ and R₃ are each independently a tert-butyl group, a 1,1-dimethylbutyl group or a tert-amyl group.

8. The photothermographic material of claim 6, wherein R₂ and R₃ are tert-amyl groups.

9. The photothermographic material of claim 1, wherein in formula (1), n and m are each 3.

10. The photothermographic material of claim 1, wherein the photothermographic material further comprises a reducing agent, except for the reducing agent represented by formula (1).

11. A bisphenol compound represented by the following formula (1): 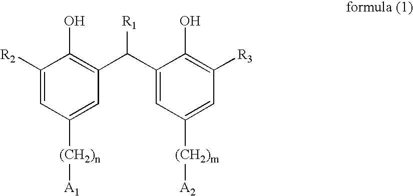
wherein R₁ is a hydrogen atom or a substituent; R₂ and R₃ are each independently a branched alkyl group having 3 to 6 carbon atoms; A₁ and A₂ are each independently a hydroxy group or a group capable of forming a hydroxy group upon deprotection; n and m are each an integer of 3 to 5.

12. The compound of claim 11, wherein in formula (1), A₁ and A₂ are each a hydroxy group.

13. The compound of claim 11, wherein in formula (1), A₁ and A₂ are each a group capable of forming a hydroxy group upon deprotection.

14. The compound of claim 11, wherein in formula (1), R₁ is a hydrogen atom, an alkyl group, a cycloalkyl group, an alkenyl group, an alkynyl, an aryl group, a heterocyclic group, a halogen atom or a cyano group.

15. The compound of claim 14, wherein R₁ is a hydrogen atom or an alkyl group.

16. The compound of claim 11, wherein in formula (1), R₂ and R₃ are each independently a tertiary alkyl group.

17. The compound of claim 16, wherein R₂ and R₃ are each independently a tert-butyl group, a 1,1-dimethylbutyl group or a tert-amyl group.

18. The compound of claim 16, wherein R₂ and R₃ are tert-amyl groups.

19. The compound of claim 11, wherein in formula (1), n and m are each 3.
